(19) United States
(12) Patent Application Publication
(10) Pub. No.: US 2024/0102938 A1
(43) Pub. Date: Mar. 28, 2024

(54) ARTIFACT-BASED FAULT DETECTION FOR PHYSICAL COMPONENTS

(71) Applicant: Apple Inc., Cupertino, CA (US)

(72) Inventors: Mikael B. MANNBERG, San Jose, CA (US); KAI ZHENG, Cupertino, CA (US)

(21) Appl. No.: 18/213,203

(22) Filed: Jun. 22, 2023

Related U.S. Application Data
(60) Provisional application No. 63/409,480, filed on Sep. 23, 2022.
(60) Provisional application No. 63/409,496, filed on Sep. 23, 2022.
(60) Provisional application No. 63/409,490, filed on Sep. 23, 2022.
(60) Provisional application No. 63/409,487, filed on Sep. 23, 2022.
(60) Provisional application No. 63/409,485, filed on Sep. 23, 2022.
(60) Provisional application No. 63/409,482, filed on Sep. 23, 2022.
(60) Provisional application No. 63/409,474, filed on Sep. 23, 2022.
(60) Provisional application No. 63/409,478, filed on Sep. 23, 2022.

(51) Int. Cl. G01N 21/88; G06T 7/00; G06T 7/50; G06T 7/62; G06T 7/90; G06V 10/764

(52) U.S. Cl. CPC G01N 21/8851; G01N 21/8806; G06T 7/0008; G06T 7/50; G06T 7/62; G06T 7/90; G06V 10/764; G01N 2021/8854; G06T 2207/10024

(57) ABSTRACT

This disclosure provides more effective and/or efficient techniques for detecting faults with physical components using an example of selectively causing output of light into a cover and capturing an image of the cover to determine whether the light is visible in the image. Some techniques are described herein for detecting misalignment of one or more physical components (e.g., a cover or a camera). Other techniques are described herein for detecting contaminants (e.g., substances at or near a surface of a physical component and/or a physical change to the physical component, such as a deformation or a crack of the cover) affecting data captured by a sensor.

### CROSS-REFERENCE TO RELATED APPLICATIONS

The present application claims benefit of U.S. Provisional Patent Application Ser. No. 63/409,480, entitled “FAULT DETECTION FOR PHYSICAL COMPONENTS” filed on Sep. 23, 2022, U.S. Provisional Patent Application Ser. No. 63/409,496, entitled “FAULT DETECTION FOR PHYSICAL COMPONENTS” filed on Sep. 23, 2022, U.S. Provisional Patent Application Ser. No. 63/409,490, entitled “FAULT DETECTION FOR PHYSICAL COMPONENTS” filed on Sep. 23, 2022, U.S. Provisional Patent Application Ser. No. 63/409,487, entitled “FAULT DETECTION FOR PHYSICAL COMPONENTS” filed on Sep. 23, 2022, U.S. Provisional Patent Application Ser. No. 63/409,485, entitled “FAULT DETECTION FOR PHYSICAL COMPONENTS” filed on Sep. 23, 2022, U.S. Provisional Patent Application Ser. No. 63/409,482, entitled “FAULT DETECTION FOR PHYSICAL COMPONENTS” filed on Sep. 23, 2022, U.S. Provisional Patent Application Ser. No. 63/409,474, entitled “FAULT DETECTION FOR PHYSICAL COMPONENTS” filed on Sep. 23, 2022, and U.S. Provisional Patent Application Ser. No. 63/409,478, entitled “FAULT DETECTION FOR PHYSICAL COMPONENTS” filed on Sep. 23, 2022, which are all hereby incorporated by reference in their entirety for all purposes.

### BACKGROUND

Today, electronic devices often have many different physical components, such as a button, a touch screen, a rotatable input mechanism, a housing, a transparent cover (e.g., a glass cover), and/or a camera. Such physical components traditionally need to be inspected by a person to determine whether they have a fault, such as a misalignment, a crack, a deformation, or a substance on a surface. Accordingly, there is a need to improve fault detection for physical components.

### SUMMARY

Current techniques for detecting faults with physical components are generally ineffective and/or inefficient. This disclosure provides more effective and/or efficient techniques for detecting faults with physical components using an example of causing output of light into a cover and capturing an image of the cover to determine whether the light is visible in the image. It should be recognized that other emissions, sensors, and/or physical components can be used with techniques described herein. For example, heat can be detected by a thermometer to determine whether a housing is intact. In addition, techniques optionally complement or replace other techniques for detecting faults in physical components.

Some techniques are described herein for detecting misalignment of one or more physical components (e.g., a cover (e.g., a glass cover, a plastic cover, or other material with internal reflective properties) and/or a camera). In some examples, such techniques attempt to detect light in an image at expected locations to determine whether a cover has maintained a previous alignment with a camera. In such examples, the cover is determined to be misaligned when the light is not detected at an expected location of the image. In other examples, images from multiple cameras are compared to detect light at respective expected locations to determine whether one of the cameras is misaligned with another of the cameras. In some examples, positions of the expected locations described above are based on sensor data such that the expected locations change based on current sensor data being detected. In some examples, the accuracy required of the expected locations decreases over time such that an area determined to be within an expected location grows over time. In the examples discussed in this paragraph, light may be selectively output depending on whether determining to attempt to detect misalignment.

Other techniques are described herein for detecting contaminants (e.g., substances at or near a surface of a physical component and/or a physical change to the physical component, such as a deformation or a crack of the physical component) affecting data captured by a sensor. Unlike the techniques described above, the determination can be based on whether a threshold amount of the light is visible in the image. In some examples, different colors of light are injected into the cover and/or different colors of light are identified in an image to detect different faults (e.g., particular colors of light are output to detect misalignment as opposed to a contaminant, particular colors of light are output to detect different types of contaminants, and/or particular colors of light are detected in an image to detect different types of contaminants). In some examples, a system includes multiple covers that can use techniques described above for detecting misalignment and/or contaminants using a single image. In the examples discussed in this paragraph, light may be selectively output depending on whether determining to attempt to detect misalignment and/or a contaminant.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system.

FIG. 2 is a block diagram illustrating a device with interconnected subsystems.

FIG. 3 is a block diagram illustrating an electronic device for detecting faults with a physical component.

FIG. 4A is a block diagram illustrating a configuration for detecting faults using a cover.

FIG. 4B is a block diagram illustrating an image captured using the configuration of FIG. 4A.

FIG. 5A is a block diagram illustrating a configuration for detecting a contaminant affecting a cover.

FIG. 5B is a block diagram illustrating an image captured using the configuration of FIG. 5A.

FIG. 6A is a block diagram illustrating a configuration for detecting misalignment and/or a contaminant.

FIG. 6B is a block diagram illustrating an image captured using the configuration of FIG. 6A.

FIG. 7 is a block diagram illustrating a configuration for detecting different types of faults in multiple covers.

FIG. 8 is a flow diagram illustrating a method for detecting misalignment of a physical component.

FIG. 9 is a flow diagram illustrating a method for detecting a contaminant affecting a physical component.

FIG. 10 is a flow diagram illustrating a method for using light to detect different faults affecting a physical component.

FIG. 11 is a flow diagram illustrating a method for changing wavelength of light that is output based on a physical environment.

FIG. 12 is a flow diagram illustrating a method for detecting faults with multiple physical components at the same time.

FIG. 13 is a flow diagram illustrating a method for detecting a fault with a camera.

FIG. 14 is a flow diagram illustrating a method for estimating a location of an artifact based on environmental data.

FIG. 15 is a flow diagram illustrating a method for estimating a location of an artifact based on an indication of time.

### DETAILED DESCRIPTION

The following description sets forth exemplary techniques, methods, parameters, systems, computer-readable storage mediums, and the like. It should be recognized, however, that such description is not intended as a limitation on the scope of the present disclosure. Instead, such description is provided as a description of exemplary embodiments.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described embodiments. In some examples, the first subsystem and the second subsystem are two separate references to the same subsystem. In some embodiments, the first subsystem and the second subsystem are both subsystem, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

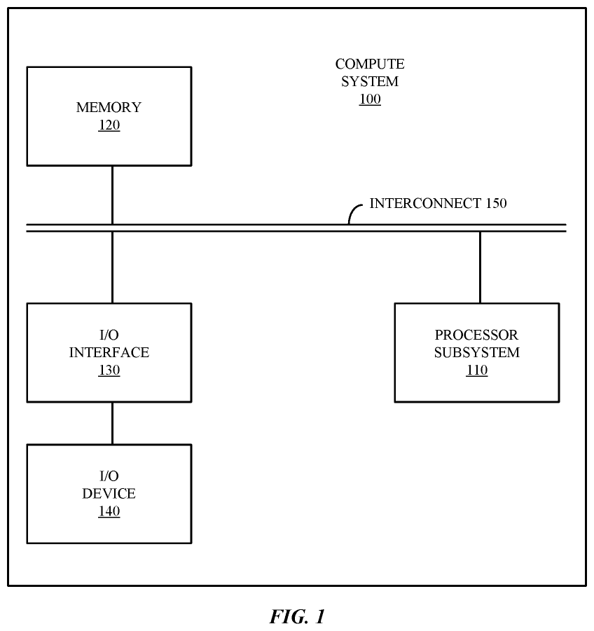

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 coupled (e.g., wired or wirelessly) to memory 120 (e.g., a system memory) and I/O interface 130 via interconnect 150 (e.g., a system bus, one or more memory locations, or other communication channel for connecting multiple components of compute system 100). In addition, I/O interface 130 is coupled (e.g., wired or wirelessly) to I/O device 140. In some examples, I/O interface 130 is included with I/O device 140 such that the two are a single component. It should be recognized that there can be one or more I/O interfaces, with each I/O interface coupled to one or more I/O devices. In some examples, multiple instances of processor subsystem 110 can be coupled to interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some examples, compute system 100 is included with or coupled to a physical component for the purpose of modifying the physical component in response to an instruction. In some examples, compute system 100 receives an instruction to modify a physical component and, in response to the instruction, causes the physical component to be modified. In some examples, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some examples, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some examples, a sensor includes a combination of multiple sensors. In some examples, sensor data is captured by fusing data from one sensor with data from one or more other sensors. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that processor subsystem 110 can execute. In such examples, the priority assigned to a task is used to identify a next task to execute. In some examples, the priority-based scheduler identifies a next task to execute when a previous task finishes executing. In some examples, the highest priority task runs to completion unless another higher priority task is made ready.

In some examples, the middleware system provides one or more services and/or capabilities to applications (e.g., the one or more applications running on processor subsystem 110) outside of what the operating system offers (e.g., data management, application services, messaging, authentication, API management, or the like). In some examples, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some examples, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some examples, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 800, 900, 1000, 11000, 12000, 1300, 1400, and 1500 described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to couple to and communicate with other devices. In some examples, I/O interface 130 includes a bridge chip (e.g., Southbridge) from a front-side bus to one or more back-side buses. I/O interface 130 can be coupled to one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is coupled to a network via a network interface device (e.g., configured to communicate over Wi-Fi, Bluetooth, Ethernet, or the like). In some examples, compute system 100 is directly or wired to the network.

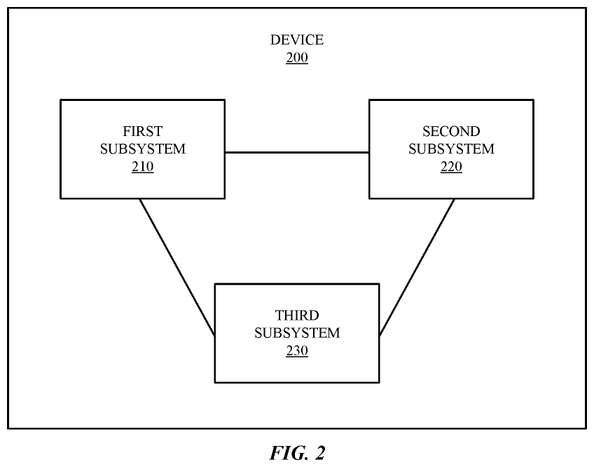

FIG. 2 illustrates a block diagram of device 200 with interconnected subsystems. In the illustrated example, device 200 includes three different subsystems (i.e., first subsystem 210, second subsystem 220, and third subsystem 230) coupled (e.g., wired or wirelessly) to each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some examples, some subsystems are not connected to other subsystem (e.g., first subsystem 210 can be connected to second subsystem 220 and third subsystem 230 but second subsystem 220 cannot be connected to third subsystem 230). In some examples, some subsystems are connected via one or more wires while other subsystems are wirelessly connected. In some examples, messages are set between the first subsystem 210, second subsystem 220, and third subsystem 230, such that when a respective subsystem sends a message the other subsystems receive the message (e.g., via a wire and/or a bus). In some examples, one or more subsystems are wirelessly connected to one or more compute systems outside of device 200, such as a server system. In such examples, the subsystem can be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some examples, device 200 is configured to navigate (with or without user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some examples, at least a portion of device 200 functions as a distributed compute system. For example, a task can be split into different portions, where a first portion is executed by first subsystem 210 and a second portion is executed by second subsystem 220.

Attention is now directed towards techniques for detecting faults (e.g., physical faults and/or mechanical faults) with physical components. Such techniques are described in the context of a camera capturing an image of a cover (e.g., a glass cover, a plastic cover, or other material with internal reflective properties) when a light source has selectively (e.g., in response to the light source or another component determining to detect whether a fault is present) output light. It should be understood that other types of sensors, physical components, and/or emitters are within scope of this disclosure and can benefit from techniques described herein. For example, a temperature sensor can detect a current temperature of an at least partially enclosed area of an electronic device when a heat source is producing heat to determine whether the enclosed area has become deformed.

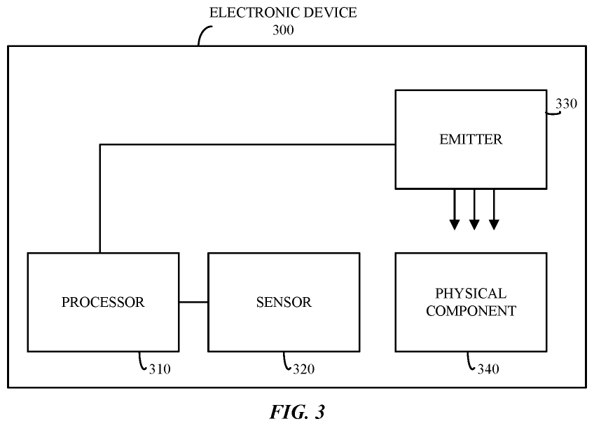

FIG. 3 is a block diagram illustrating electronic device 300. As depicted, electronic device 300 includes processor 310, sensor 320, emitter 330, and physical component 340. It should be recognized that electronic device 300 can include more or fewer components, such as components described above with respect to FIGS. 1 and 2.

In some examples, processor 310 is an electrical component (e.g., a digital circuit and/or an analog circuit) that performs one or more operations. For example, processor 310 can be a central processing unit (CPU), such as a microprocessor, a microcontroller, an application-specific integrated circuit (ASIC), or a field-programmable gate array (FPGA). In some examples, processor 310 is communicating (e.g., wired or wirelessly) with one or more other components of electronic device 300. For example, FIG. 3 illustrates processor 310 in communication with sensor 320 and emitter 330.

In some examples, sensor 320 is a hardware component (e.g., a digital or analog device) that outputs a signal based on an input from a physical environment. Examples of sensor 320 are described above with respect to FIG. 1. For discussion purposes hereafter, sensor 320 is a camera configured to capture an image.

In some examples, emitter 330 is a hardware component (e.g., a device) that outputs a type of signal or other medium (sometimes referred to as an emission), including light, sound, odor, taste, heat, air, and/or water. In some examples, emitter 330 intermittently emits an emission, such as in response to receiving a request from another component and/or another device or in response to determining to emit the emission itself. In such examples, emitter 330 will sometimes be emitting the emission and sometimes not emitting the emission, such as on a period time-based schedule or in response to determining that certain events have occurred. Such a configuration allows for the emission to not continuously (e.g., always) interfere with data detected by sensor 320. For discussion purposes hereafter, emitter 330 is a light source configured to output light (e.g., collimated light sometimes referred to as a collimated beam of light) toward physical component 340. In some examples, emitter 330 can change from outputting light of a first set of one or more wavelengths (e.g., a first color) to outputting light of a second set of one or more wavelengths (e.g., a second color that is different from the first color) (e.g., the same or different number of wavelengths as the first set of one or more wavelengths).

In some examples, physical component 340 is any tangible part of electronic device 300. Examples of physical component 340 include a semiconductor, a display component, a vacuum tube, a power source, a resistor, a capacitor, a button, a keyboard key, a slider, a rotatable input mechanism, a touch screen, at least a portion of a housing, an at least partially transparent cover (referred to as a transparent cover, such as a glass or plastic cover), a sensor, a processor, an emitter, and/or an actuator. For discussion purposes hereafter, physical component 340 is a cover to protect sensor 320 from a physical environment (e.g., rain, dust, dirt, or rocks). In some examples, physical component 340 has an optical power that shifts a location of objects in an image captured by sensor 320. In some examples, physical component 340 is transparent and/or one or more portions of physical component 340 is transparent, such that light from emitter 330 passes through the transparent portion(s) of physical component 340.

In the configuration above, electronic device 300 detects faults with physical component 340 and/or sensor 320 by sensor 320 capturing an image of physical component 340 when light is selectively injected into physical component 340 by emitter 330, as further discussed below.

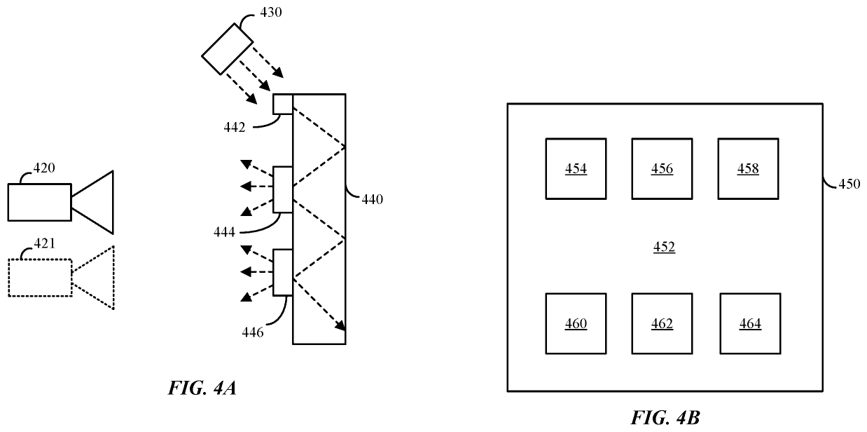

FIG. 4A is a block diagram illustrating a configuration for detecting faults using cover 440. As depicted, the configuration includes camera 420, light source 430, cover 440, and multiple optical elements (e.g., incoupling element 442, outcoupling element 444, and outcoupling element 446). It should be recognized that the multiple components depicted in FIG. 4A can be part of (e.g., integrated into or coupled to (e.g., permanently coupled and/or not intended to be configured to be uncoupled and recoupled)) a single component, such as cover 440 can be part of camera 420, light source 430 can be part of camera 420 or cover 440, incoupling element 442 can be part of camera 420 or cover 440, and/or one or more outcoupling elements can be part of cover 440.

In some examples, camera 420 has a field of view (a portion of a physical environment that will be included in an image captured by camera 420) that includes at least a portion of cover 440. In some examples, light source 430 is outside of the field of view of camera 420 such that images captured by camera 420 do not include light source 430. In other examples, the field of view of camera 420 includes light source 430.

As mentioned above, FIG. 4A depicts multiple optical elements, including incoupling element 442 and multiple outcoupling elements (e.g., first outcoupling element 444 and second outcoupling element 446), each optical element configured to redirect light output by light source 430. In some examples, incoupling element 442 and/or one or more of the multiple outcoupling elements is configured such that there is not an airgap between such elements and cover 440. It should be recognized that more or fewer incoupling and/or outcoupling elements can be included. For example, there can be no incoupling element and/or 4 or more outcoupling elements.

In some examples, an incoupling element is configured to receive light (e.g., light output from light source 430) and redirect the light in a different direction (e.g., into cover 440 at an angle that ensures the light is reflected inside of cover 440). Examples of incoupling element include a lens, a collimator, a mirror, and a prism.

In some examples, an outcoupling element is configured to receive light (e.g., light reflected from a surface of cover 440) and redirect the light in a different direction (e.g., out of cover 440, such as toward camera 420). Examples of outcoupling elements include a mirror, a film (e.g., that is applied locally to a part of cover 440), a marker chemically etched or laser engraved onto cover 440, a diffractive optical element, a three-dimension structure (e.g., a cone) embedded into cover 440, and/or one or more layers of diffractive grating arrays.

In some examples, outcoupling elements are included in cover 440 at locations of the field of view of camera 420 that are less important for other operations (e.g., object detection and/or depth calculation). For example, outcoupling elements can be included proximate to an edge of the field of view of camera 420. For another example, the field of view of camera 420 can be divided into at least three portions (e.g., a top, middle, and bottom portion) and the outcoupling elements are placed in the top and bottom portions but not the middle portion

In some examples, outcoupling elements are arranged in a pattern with respect to cover 440. For example, outcoupling elements can form a grid pattern with each outcoupling element of a set of outcoupling elements being an equal distance from each other.

In some examples, each outcoupling element of a set of outcoupling element is coplanar so as to determine one or more different axes (e.g., x, y, z, pitch, yaw, and/or roll). In such examples, more outcoupling elements can be used with more complicated configurations, such as a cover that includes more than one plane and/or is at risk of becoming deformed.

Using the configuration described above for FIG. 4A, light source 430 or a computer system (e.g., electronic device 300 or device 200) in communication with light source 430 determines whether to output light (e.g., light is not continuously output but rather intermittently output based on a determination). For example, light source 430 can be configured to output light at a particular frequency (e.g., every second, every minute, and/or every hour) and no instruction is sent to light source 430 to cause output of light. For another example, the computer system can be configured to cause output of light at a particular frequency (e.g., periodically, such as every minute and/or every 5 minutes) by sending a request to output light to light source 430. For another example, the computer system can determine that an event occurred (e.g., an event that could cause a fault) and, in response to determining that the event occurred, cause light source 430 to output the light by sending a request to output light to light source 430. In such an example, the event can be determined based on a sensor (e.g., an image captured by camera 420, an accelerometer detecting a sudden acceleration/deceleration, a gyroscope detecting a sudden change in orientation, a speedometer detecting a sudden change in speed (e.g., velocity), a thermometer detecting a change in temperature, and/or a humidity sensor detecting a change in humidity). For another example, the computer system can be executing an operation using data captured by camera 420 and, while executing the operation, determine that a result (e.g., a calculation and/or a determination) is inconsistent with an expected and then cause light source 430 to output light.

Continuing the example above, light source 430 outputs light toward incoupling element 442. In some examples, light source 430 outputs the light for an amount of time to capture a single image (e.g., a single frame). In other examples, light source 430 outputs the light for an amount of time to capture multiple images (e.g., multiple frames). In either set of examples, a computer system can determine how many frames to capture and cause the light to be output for long enough to capture that many frames. Different amounts of frames can be captured at different times such that the light is not always output for the same amount of time. For example, the computer system can cause light source 430 to output light for a single frame to determine whether the computer system detects enough information. If the computer system does not detect enough information, the computer system can cause light source 430 to output light for multiple frames.

Continuing the example above, incoupling element 442 redirects the light into cover 440. The light is then internally reflected in cover 440. When the light is directed to an outcoupling element while reflecting in cover 440, at least a portion of the light is redirected out of cover 440 and at least partially toward camera 420. While light is being directed toward camera 420, camera 420 captures an image that includes artifacts of the light (e.g., a pattern, mark, and/or a color corresponding to the light (e.g., the same color as is output) will appear in particular locations within the image). The image is then used to determine whether the artifacts of the light are located in expected positions (sometimes referred to as estimated positions) within the image (e.g., positions corresponding to the outcoupling elements when camera 420 and cover 440 are aligned in one or more different axes (e.g., x, y, z, pitch, yaw, and/or roll).

When a determination is made that the artifacts are detected in the expected positions, camera 420 and cover 440 are determined to have maintained alignment, and when the artifacts are located in different positions, camera 420 and cover 440 are determined to be misaligned (e.g., or that the alignment has changed). In some examples, sensor 320 captures images while light is not being directed toward camera 420. In such examples, the images would not include artifacts of the light and therefore can be used for other operations, even in locations that would include artifacts when light is being directed toward camera 420.

In some examples, a corrective action is performed when it is determined that camera 420 and cover 440 are misaligned. For example, the misalignment can be considered when using data captured by camera 420 (e.g., an offset can be applied to calculations using the data). For another example, the misalignment can be reported to a user, such as through an indication on a device including camera 420 or an indication on a separate device, such as a personal device of the user.

In some examples, the expected locations described above are configured to adapt to changes. In other words, a determination of where the expected locations are dynamic and change based on current conditions. For example, a computer system estimating an expected location can receive data from a sensor (or from a remote device) and, in response to the data, determine where the expected location should be. In such an example, the data can include a temperature, a humidity level, a change in speed, acceleration, and/or orientation. Then, based on the data, the computer system can determine that a focal length of camera 420 has grown or shrank (e.g., as temperature goes from a cooler to a warmer temperature, a camera barrel can enlarge causing a focal length to enlarge; and as temperature goes from a warmer to a cooler temperature, a camera barrel can shrink causing a focal length to shrink), and therefore, the expected location should be changed to accommodate the change in the focal length. In one example, the computer system can include a lookup table that correlates sensor data with different focal lengths, where the lookup table is used to determine a current focal length when current sensor data is detected. In such examples, a sensor detecting the current conditions can be attached and/or in proximity to camera 420 and/or cover 440 so that the current conditions are similar to (or same as) current conditions of camera 420 and/or cover 440. For example, camera 420 can include a camera sensor on one side of a surface, and on the opposite side of the surface (e.g., on the back side of the camera sensor), camera 420 can include a sensor for detecting current conditions.

In some examples, an expected location described above is configured to include more area of the image as time passes. For example, a computer system can predict a particular location to be where an artifact of light should be detected at a first time. After the first time, the computer system can predict a second location in addition to the particular location to be where an artifact of light should be detected after the first time, indicating that the computer system has expanded where the artifact can be located to still be within normal operating parameters and to not have a fault. In such examples, time can be measured in a number of ways, including time since camera 420 has been operating, time since camera 420 last switched from an off or standby state to an on or active state, number of power cycles that camera 420 has had, and/or an absolute time since first activating camera 420.

In some examples, the configuration includes one or more additional cameras (e.g., camera 421). When the configuration includes multiple cameras, the computer system can determine whether a camera of the multiple cameras is misaligned with another camera using techniques described herein. For example, light can be output via light source 430 similar to as described above. The difference is that, instead of capturing a single image using camera 420, images are captured with both camera 420 and camera 421. Using the two images (one from each camera) and geometry of where the cameras should be aligned, expected locations of artifacts of the light are determined for each image. If an expected location is not present in one of the images (e.g., an artifact corresponding to the expected location is at a different location), the computer system can determine that the camera that captured the image that is missing the artifact at the expected location has changed alignment with respect to the other camera. In such examples, the computer system can compensate for this misalignment going forward when performing operations and detecting whether there is misalignment with cover 440 and/or one of the cameras. In other examples, the computer system can cause one of the cameras to be moved when it is determined that there is misalignment between the cameras.

FIG. 4B is a block diagram illustrating image 450 captured using the configuration of FIG. 4A. Image 450 includes content 452 and multiple artifacts (e.g., artifacts 454, 456, 458, 460, 462, and 464). Content 452 represents a scene in a physical environment being captured in image 450, such as a scene that includes a dog, cat, person, and/or the environment. The multiple artifacts are caused by outcoupling elements redirecting light out of a cover (e.g., cover 440 in FIG. 4A). As depicted, there are six different artifacts in image 450, indicating that cover 440 has at least six different outcoupling elements (e.g., a single outcoupling element for each artifact). As can be seen, the multiple artifacts are in the top and bottom of image 450, leaving the middle of image 450 without any artifacts and able to have operations performed on such without being interfered by an artifact.

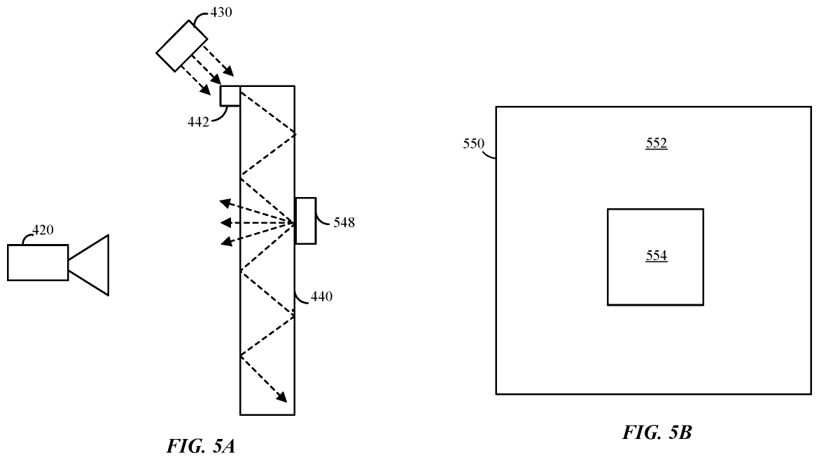

FIG. 5A is a block diagram illustrating a configuration for detecting contaminant 542 affecting cover 540. Similar to FIG. 4A, the configuration of FIG. 5A includes camera 420, light source 430, cover 440, and incoupling element 442. Accordingly, the configuration of FIG. 5A performs many of the same operations as described in FIG. 4A, including light source 430 or a computer system determines whether to output light, light source 430 outputs light toward incoupling element 442 (e.g., for a length of time corresponding to one or more frames) in response to determining to output light, incoupling element 442 redirects the light into cover 440, and the light is internally reflected in cover 440.

Unlike FIG. 4A, the configuration of FIG. 5A does not include outcoupling elements, so light is not directed out of cover 440 at locations corresponding to outcoupling elements. Instead, light is directed out of cover 440 when interacting with contaminant 548 and/or a fault in cover 440 (e.g., a crack in cover 440). For example, light reflecting from a surface of cover 440 that, on one side of surface or the other, includes contaminant 548 (e.g., dirt, water, or any physical substance that would affect reflection of light) is redirected to a direction that would not be internally reflected and instead be directed out of cover 440 and toward camera 420 (as illustrated in FIG. 5A).

While light is being directed toward camera 420 (e.g., after interacting with contaminant 548), camera 420 captures an image that includes an artifact of the light (e.g., a color corresponding to the light (e.g., a color not absorbed by contaminant 548, such as a color different from the light output by light source 430) will appear in the image due to exiting cover 540 in a direction toward camera 420). The image is then used to determine whether a threshold amount (e.g., more than none, more than a predefined amount, a particular size, and/or a particular shape) of the artifact of the light is located in the image. In response to the threshold amount of the artifact being detected, cover 440 is determined to be affected by contaminant 542, and, in response to the threshold amount of the artifact not being detected, cover 440 is determined to not be affected by contaminant 542. In some examples, in response to cover 440 being determined to be affected by contaminant 542, a computer system can attempt to remove contaminant 542. In other examples, the computer system can determine to not use an area of an image captured by camera 420 corresponding to contaminant 542 for other operations (e.g., object identification and/or depth calculation). In other examples, the computer system can notify a user, such as through an indication on a device including camera 420 or an indication on a separate device, such as a personal device of the user.

In some examples, sensor 320 captures images while light is not being directed toward camera 420. In such examples, the images would not be analyzed for whether they include an artifact of the light and, therefore, can be used for other operations, even in locations that would include artifacts when light is being directed toward camera 420.

In some examples, light source 430 outputs light including multiple wavelengths. In such examples, different wavelengths of the light will be absorbed by contaminant 542, causing a different wavelength of light to be output toward camera 420 than the light output by light source 430. By determining the wavelength of light output toward camera 420 in an image, a particular type of contaminant can be detected (e.g., particular wavelengths of light will be included in the image depending on which type of contaminant). In other examples, light source 430 is configured to change what set of one or more wavelengths are included in light output by light source 430. In such examples, different types of contaminants can be tested for depending on which wavelengths are included in light output by light source 430. In some examples, a computer system can perform different operations depending on which contaminant is detected. For example, the computer system can perform an operation that is intended to remove a particular type of contaminant based on what type of contaminant is detected (e.g., water might require a physical component to wipe cover 440 and ice might require heat to be applied to cover 440).

FIG. 5B is a block diagram illustrating image 550 captured using the configuration of FIG. 5A. Image 550 includes content 552 and artifact 554. Content 552 is representative of the scene in a physical environment being captured in image 450. Artifact 554 is caused by a contaminant (e.g., contaminant 548) redirecting light out of a cover (e.g., cover 440 in FIG. 5A). The size of artifact 554 indicates an amount of contaminant on the cover. As can be seen, artifact 554 is in the middle of image 550, leaving the outside of image 550 without any artifacts and able to have operations performed on such without being interfered by an artifact.

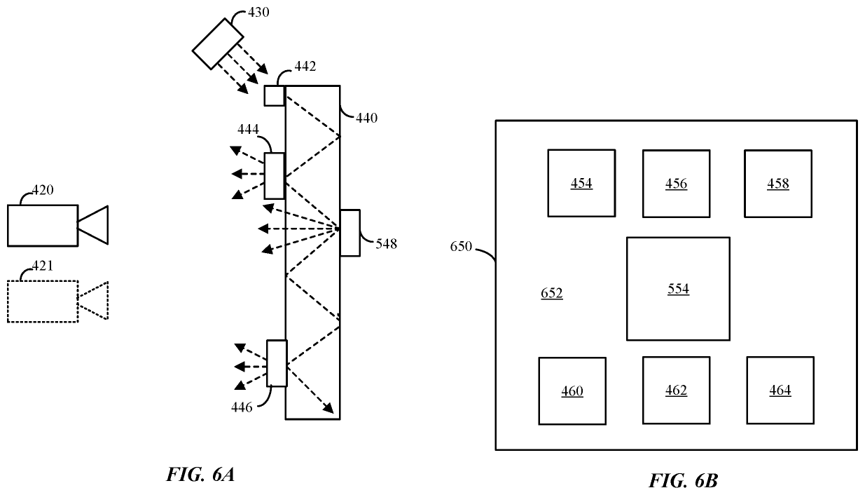

FIG. 6A is a block diagram illustrating a configuration for detecting misalignment and/or contaminant 648. Similar to FIG. 4A, the configuration of FIG. 6A includes camera 420, light source 430, cover 440, and multiple optical elements (e.g., incoupling element 442, outcoupling element 444, and outcoupling element 446). In particular, the configuration of FIG. 6A includes the same configuration as FIG. 4A with the added detection of contaminant 548 from FIG. 5A. For example, light source 430 and/or a computer system can determine to output a light with one or more wavelengths, and in response to the determination, light source 430 can output a light with the one or more wavelengths in a direction of incoupling element 442. Incoupling element 442 can redirect the light into cover 440, where the light will be internally reflected. When the light is directed to outcoupling element 444 and/or outcoupling element 446, at least a portion of the light will be output outside of cover 440 toward camera 420. Similarly, when the light is directed to contaminant 548, at least a portion of light will be output outside of cover 440 toward camera 420. While light is being output outside of cover 440, camera 420 can capture an image that includes artifacts of the light, as depicted in FIG. 6B and discussed further below.

In some examples, a computer system can perform multiple detection operations using the same configuration at the same time or different times (e.g., a different detection operation at a first time than a second time), such as both misalignment detection (e.g., of cover 440 and/or camera 420, 421) and contaminant detection. For example, the computer system can determine what detection operations to perform and cause output of light corresponding to whatever detection operations are determined to be performed. For another example, the computer system can attempt to detect artifacts of light in the image at locations corresponding to outcoupling elements for misalignment detection and other artifacts of light at other locations for contaminant detection. The artifacts of light corresponding to outcoupling element can be the same color as output by light source 430 and an artifact resulting from a contaminant can be the same or different color as output by light source 430. When only detecting whether a contaminant is present with the configuration of FIG. 6A, the computer system can ignore locations for which correspond to outcoupling elements.

In some examples, multiple light sources output light toward one or more incoupling elements configured to direct the light into cover 440 (e.g., incoupling element 442). In such examples, different light sources can be intended to detect different type of faults. For example, a first light source can be configured to output a light with a particular wavelength that is configured to detect misalignment of cover 440 (e.g., only a single wavelength). In such an example, a second light source can be configured to output a light with a different wavelength that is configured to detect contaminant affecting cover 440 (e.g., one or more wavelengths with at least one different wavelength that the single wavelength used to detect misalignment; e.g., a set of wavelengths not including the single wavelength used to detect misalignment).

FIG. 6B is a block diagram illustrating image 650 captured using the configuration of FIG. 6A. Image 650 includes content 652 and multiple artifacts (e.g., artifacts 454, 456, 458, 460, 462, 464, and 554). Content 652 is representative of a scene is in a physical environment being captured in image 650.

Artifacts 454, 456, 458, 460, 462, 464, and 554 in FIG. 6B are caused by outcoupling elements redirecting light out of a cover (e.g., cover 440 in FIG. 4A). As depicted, there are six different artifacts in image 450, indicating that cover 440 has at least 6 different outcoupling elements (e.g., a single outcoupling element for each artifact). Artifact 554 in FIG. 6B is caused by a contaminant (e.g., contaminant 548) redirecting light out of a cover (e.g., cover 440 in FIG. 6A). Similar to in FIG. 5B, the size of artifact 554 in FIG. 6B indicates an amount of contaminant on the cover. As can be seen in FIG. 6B, image 650 includes artifacts for both misalignment and contaminant detection, allowing both detections to occur with a single image by attempting to identify artifacts of outcoupling elements at their predefined locations and determining whether other artifacts are detected at other locations within the image (e.g., artifacts that are a different color than light output by light source 430).

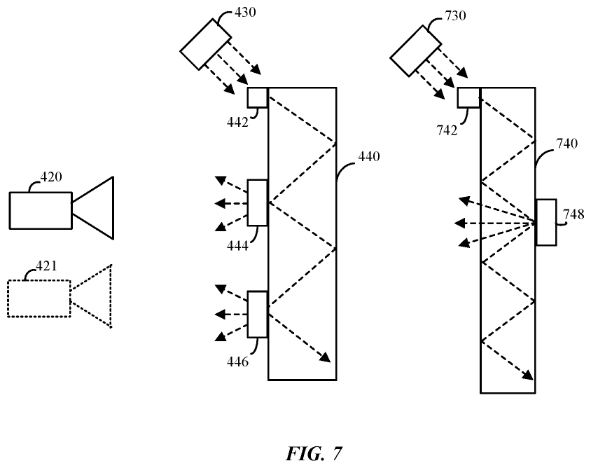

FIG. 7 is a block diagram illustrating a configuration for detecting different types of faults with multiple covers (e.g., inner cover 440 and outer cover 740). While two covers are depicted, it should be recognized that any number of covers can be used with techniques described herein.

Similar to FIG. 4A, the configuration of FIG. 7 includes camera 420, light source 430, inner cover 440, and multiple optical elements (e.g., incoupling element 442, outcoupling element 444, and outcoupling element 446). In particular, the configuration of FIG. 6A includes the same configuration as FIG. 4A with another layer of cover and accompanying elements. For example, the configuration of FIG. 7 further includes light source 730, outer cover 740, and incoupling element 742. In some examples, the configuration of FIG. 7 further includes multiple outcoupling elements corresponding to outer cover 740 to detect misalignment of outer cover 740 with camera 420. In such examples, the multiple outcoupling elements corresponding to outer cover 740 can be located in different locations than the multiple outcoupling elements corresponding to inner cover 440 such that an image captured via camera 420 is able to view, without obstruction, artifacts corresponding to light from both inner cover 440 and outer cover 740.

In some examples, using the configuration described above for FIG. 7, light source 430 and/or 730 or a computer system (e.g., electronic device 300 or device 200) in communication with light source 430 and/or 730 determines whether to output light (e.g., light is not continuously output but rather intermittently output based on a determination) using light source 430 and/or 730. For example, light source 430 and/or 730 can be configured to output light at a particular frequency (e.g., every second, every minute, and/or every hour) and no instruction is sent to light source 430 and/or 730 to cause output of light. For another example, the computer system can be configured to cause output of light at a particular frequency (e.g., periodically, such as every minute and/or every 5 minutes) by sending a request to output light to light source 430 and/or 730. For another example, the computer system can determine that an event occurred (e.g., an event that could cause a fault) and, in response to determining that the event occurred, cause light source 430 and/or 730 to output the light by sending a request to output light to light source 430 and/or 730. In such an example, the event can be determined based on a sensor (e.g., an image captured by camera 420, an accelerometer detecting a sudden acceleration/deceleration, a gyroscope detecting a sudden change in orientation, a speedometer detecting a sudden change in speed (e.g., velocity), a thermometer detecting a change in temperature, and/or a humidity sensor detecting a change in humidity). For another example, the computer system can be executing an operation using data captured by camera 420 and, while executing the operation, determine that a result (e.g., a calculation and/or a determination) is inconsistent with an expected and then cause light source 430 and/or 730 to output light.

Continuing the examples described above, light source 730 can output a light with one or more wavelengths in a direction of incoupling element 742. Incoupling element 742 can redirect the light into outer cover 740, where the light will be internally reflected. When the light is directed to contaminant 748, at least a portion of light will be output outside of outer cover 740 toward camera 420. While light is being output outside of outer cover 740, camera 420 can capture an image that includes artifacts of the light.

In some examples, light sources 430 and 730 output light at approximately the same time such that an image captured by camera 420 is able to detect artifacts of the light in an image, the artifacts corresponding to light from light source 430 and 730.

In some examples, a computer system can perform multiple detection operations using the same configuration at the same time or different times (e.g., a different detection operation at a first time than a second time), such as both misalignment detection (e.g., of cover 440 and/or camera 420, 421) and contaminant detection. In such examples, the computer system can attempt to detect artifacts of light in the image at locations corresponding to outcoupling elements and other artifacts of light at other locations. The artifacts of light corresponding to outcoupling element can be the same color as output by light source 430 and an artifact resulting from a contaminant can be the same or different color as output by light source 430. When only detecting whether a contaminant is present with the configuration of FIG. 6A, the computer system can ignore locations for which correspond to outcoupling elements.

In some examples, multiple light sources output light toward one or more incoupling elements configured to direct the light into cover 440 (e.g., incoupling element 442). In such examples, different light sources can be intended to detect different type of faults. For example, a first light source can be configured to output a light with a particular wavelength that is configured to detect misalignment of cover 440 (e.g., only a single wavelength). In such an example, a second light source can be configured to output a light with a different wavelength that is configured to detect contaminant affecting cover 440 (e.g., one or more wavelengths with at least one different wavelength that the single wavelength used to detect misalignment; e.g., a set of wavelengths not including the single wavelength used to detect misalignment).

With any of the techniques described herein with light sources capable of outputting different colors of light (e.g., light including different wavelengths of light), the computer system can detect a color within an image and determine to use a color of light that is different from the color when attempting to detect a fault. In some examples, the color within the image is a color corresponding to an expected location of an artifact of a light or a color that is predominant in a location of the image for which detection is likely to occur. In some examples, such analysis of a previous image can be used to determine whether a color detected in an image is due to light or a physical environment. In some examples, if colors within a physical environment are changing quickly, the computer system can determine to not detect whether a physical component has a fault until after the physical environment stops changing so quickly. In other examples, such analysis of a previous image can be used to determine what color to use for light (e.g., a color not present in images of the physical environment, such as a distinct color).

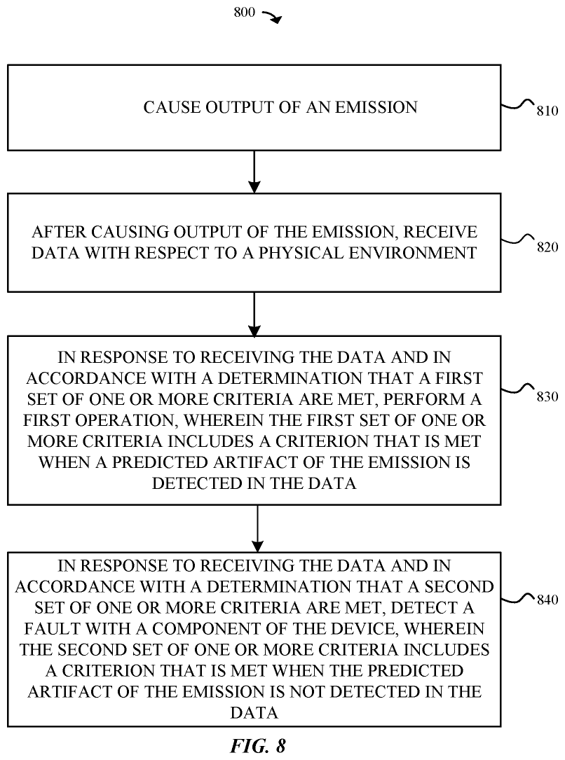

FIG. 8 is a flow diagram illustrating method 800 for detecting misalignment of a physical component. Some operations in method 800 are, optionally, combined, the orders of some operations are, optionally, changed, and some operations are, optionally, omitted. In some examples, method 800 is performed by a compute system (e.g., compute system 100), a computer system (e.g., device 200), or an electronic device (e.g., electronic device 300). In some examples, method 800 is performed by a processor (e.g., a processing unit) of an electronic device (e.g., a computer system, a phone, a tablet, a motorized electronic device, a wearable electronic device, a personal computer, and/or an autonomous electronic device) that is in communication with an emitter (e.g., a light source, such as a laser, a light bulb, a fluorescent light, and/or a light emitting diode) and a sensor (e.g., a camera and/or any sensor described herein).

At 810, method 800 includes in accordance with a determination to determine whether a component (e.g., an at least partially transparent cover and/or the sensor) (in some examples, the electronic device includes the component) has a fault (e.g., misalignment, a contaminant on the component, and/or a physical degradation or malfunction), causing, via the emitter, output of an emission (e.g., the emission is detectable by the sensor, such as light in an image when the sensor is a camera) (in some examples, the electronic device sends a request to the emitter to output the emission; in some examples, the electronic device executes an instruction to output the emission without sending and/or needing to send a request; and in some examples, the electronic device receives a request to determine whether the component has a fault and, in response to receiving the request, causes the output of the emission; in some examples, the emitter outputs an emission that has a single wavelength; in some examples, the emitter outputs an emission that has multiple wavelengths; in some examples, in accordance with a determination to not determine whether the component has a fault, forgoing causation of output of the emission).

At 820, method 800 includes after causing output of the emission (and/or in conjunction with (e.g., after and/or while) causing), receiving (e.g., causing capture of and/or obtaining), via the sensor, data with respect to a physical environment (e.g., an image, a temperature reading, and/or an amount of pressure).

At 830, method 800 includes, in response to receiving the data and in accordance with a determination that a first set of one or more criteria is met, determining that the component has a fault, wherein the first set of one or more criteria includes a first criterion that is met when a predicted artifact (e.g., a particular size, shape, color, and/or location of an artifact; e.g., an artifact includes a detectable portion and/or result of the emission) corresponding to the emission is not detected (e.g., less than a threshold amount) (e.g., using the data) (in some examples, a first operation is not performed in accordance with the determination that the first set is met).

At 840, method 800 includes, in response to receiving the data and in accordance with a determination that a second set of one or more criteria is met, performing a first operation (e.g., depth calculation, changing a state of a second component (e.g., the component or a component different from the component) of the electronic device, notifying a user, and/or any other operation that is relying on the data to be accurate) (in some examples, the first operation uses the data), wherein the second set of one or more criteria includes a second criterion that is met when the predicted artifact corresponding to the emission is detected (e.g., using the data), and wherein the second set of one or more criteria is different from the first set of one or more criteria (in some examples, in accordance with the determination that the second set of one or more criteria is met, determining that the component does not have a fault).

In some examples, the emission is light output via a light source (e.g., CCFL, EEFL, FFL, LED, radar, hot cathode fluorescent lamp (HCFL), laser, organic light emitting diode (OLED), and/or electroluminescent (EL) devices) (in some examples, the light source is outside of a field of view of the sensor; in some examples, the electronic device includes the light source).

In some examples, the light is collimated light of a single wavelength (e.g., sometimes referred to as monochromatic light).

In some examples, the sensor is a camera (e.g., a camera sensor of the camera), and wherein the data includes an image captured by the camera.

In some examples, the component includes an optical component (e.g., a glass or plastic cover and/or an at least partially transparent cover (referred to as a transparent cover)) in (e.g., at least partially) the optical path of the camera, wherein the optical component includes an embedded component (e.g., a reflecting component, such as a film, prism, 3D object, and/or a mirror, sometimes referred to as a diffuser), and wherein the first criterion is met when the predicted artifact corresponding to the emission is not detected at a location corresponding to the embedded component (in some examples, the predicted artifact is only detectable in an image captured by the camera when the emission is output; in some examples, the predicted artifact is not detectable (or less detectable) in an image captured by the camera when the emission is not being output).

In some examples, the optical component includes a plurality of embedded components, and wherein the plurality of embedded components are located proximate to an edge of a field of view of the camera.

In some examples, determining that the component includes a fault includes determining that a location or orientation of the optical component has changed relative to the camera, wherein the location and orientation are defined in 6 degrees (x, y, z, pitch, yaw, and roll) (in some examples, there are more than four when cover is not flat (e.g., the cover is deformed)) and determined based on at least 4 embedded components.

In some examples, determining that the component includes a fault includes determining that a location or orientation of an optical component of the component is misaligned with the camera (in some examples, the camera includes the component).

In some examples, method 800 further includes: in accordance with a determination to determine whether a second optical element of the component has a fault, causing, via a second emitter different from the emitter, output of a second emission different from the emission, wherein the component includes a plurality of separate, disconnected optical components including the second optical element, and wherein the plurality of separate, disconnected optical components are at least partially in the optical path of the camera.

In some examples, method 800 further includes: in accordance with a determination that the emitter is not outputting an emission, performing a second operation (e.g., object detection and/or depth calculation) different from the first operation, wherein the second operation uses data detected by the sensor.

In some examples, method 800 further includes: in response to receiving the data, performing an object detection operation using the data, wherein the object detection operation is different from (1) the first operation and (2) determining whether the component has a fault.

In some examples, the first set of one or more criteria includes a third criterion, different from the first criterion, that is met when a second predicted artifact, different from the first predicted artifact, corresponding to the emission is not detected (in some examples, each predicted artifact is predicted to be located at a different location; in some examples, a threshold number of predicted artifacts need to be undetected to determine that the component has a fault; in some examples, the different locations correspond to embedded components that are detectable by the sensor when the emission is output).

In some examples, method 800 further includes: in response to determining that the component has a fault, performing a corrective action (e.g., recalibrating one or more models to take into account the error or output a notification (e.g., a message to a user or a fault detection event)).

In some examples, method 800 further includes: periodically (e.g., every second or every minute) causing, via the emitter, output of the emission (e.g., the output of the emission is not constant but rather turned on and off over time, such as at time intervals for which the device is determining whether the component has a fault) (in some examples, the processor periodically causes output of the emission to cease).

In some examples, the output of the emission is caused in accordance with a determination (e.g., in response to determining) that a sensor (e.g., of the electronic device) detected that an event (e.g., hitting a bump, a hard turn, or an accident) occurred.

In some examples, the output of the emission is caused as a result of (e.g., in accordance with) a determination (e.g., in response to determining) that a result of an operation (e.g., the first operation or a different operation) is incorrect.

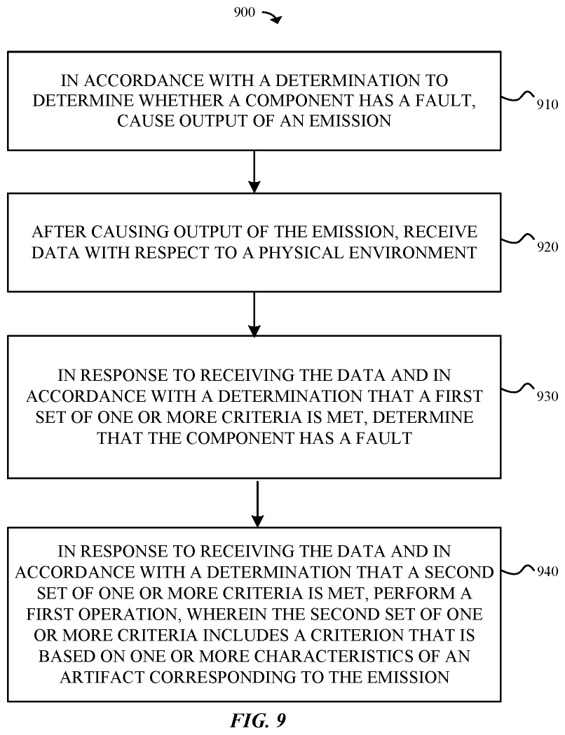

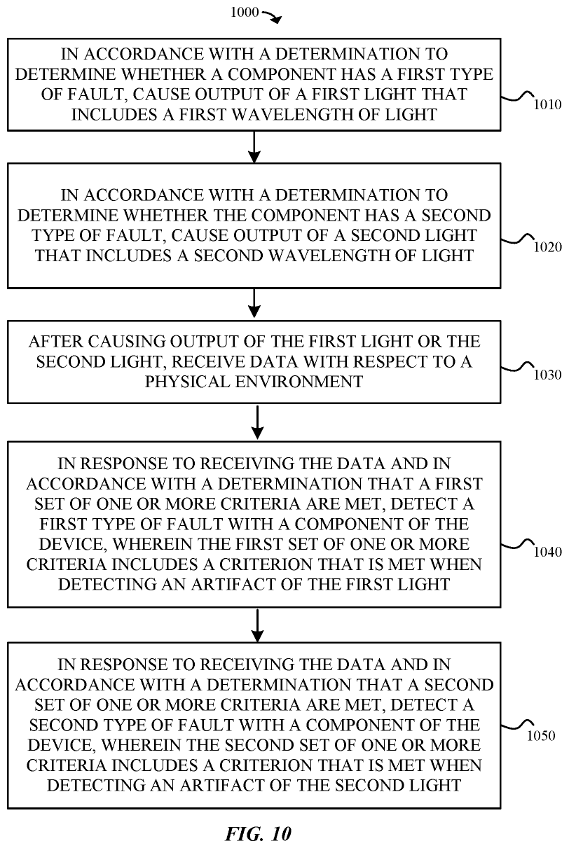

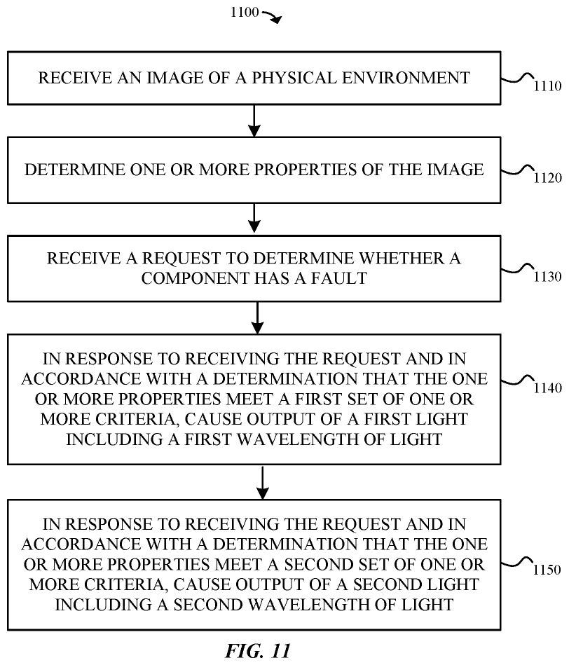

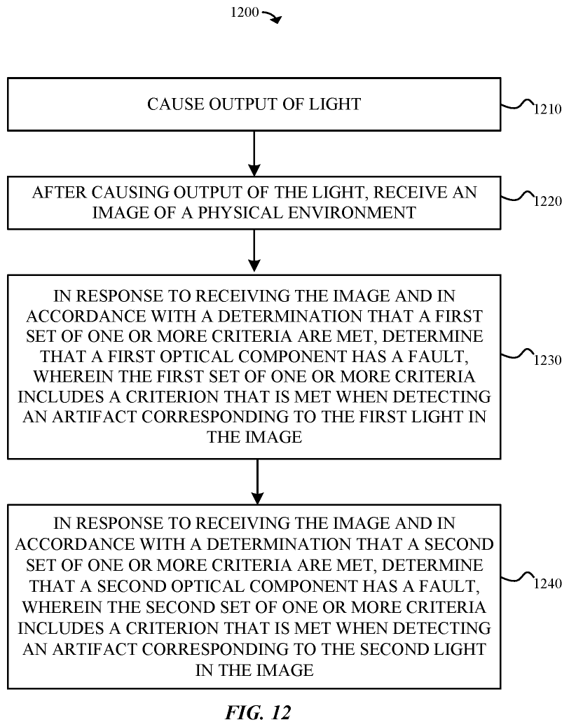

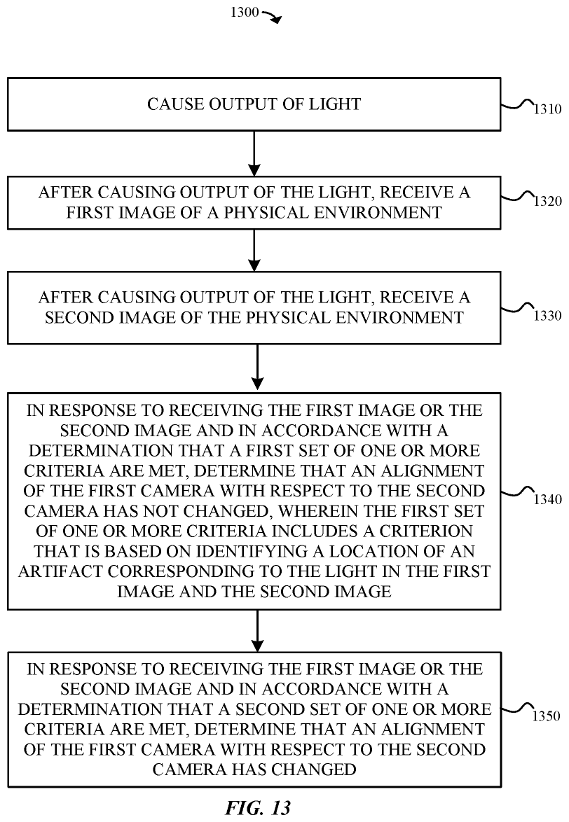

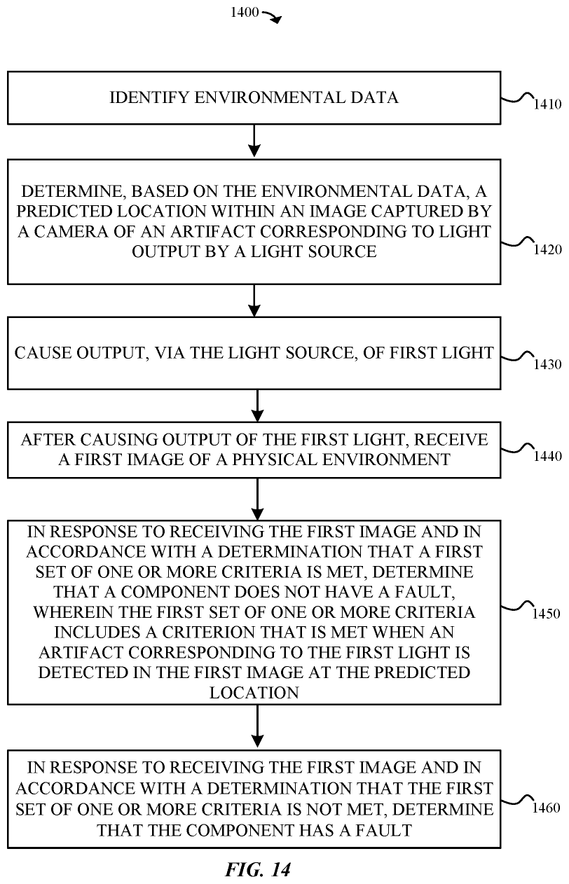

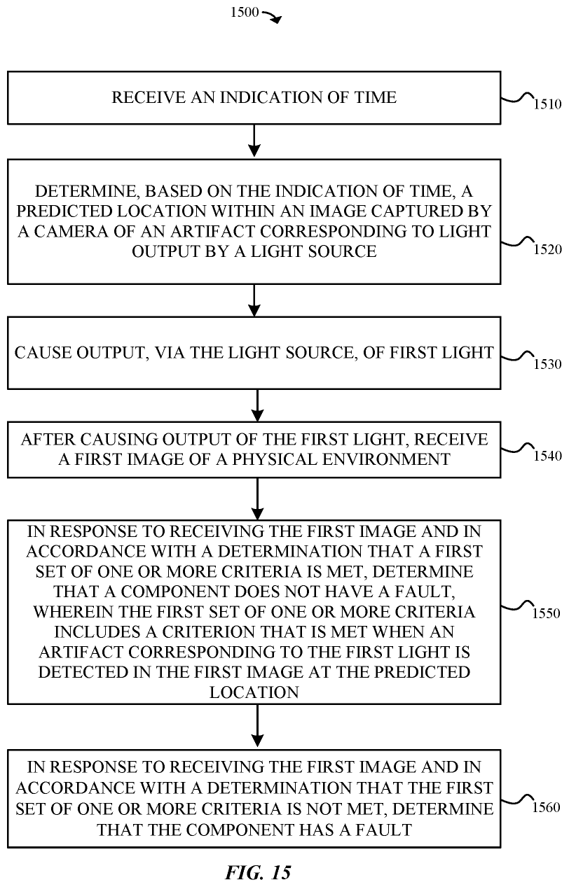

Note that details of the processes described below with respect to methods 900 (i.e., FIG. 9), 1000 (i.e., FIG. 10), 1100 (i.e., FIG. 11), 1200 (i.e., FIG. 12), 1300 (i.e., FIG. 13), 1400 (i.e., FIG. 14), and 1500 (i.e., FIG. 15) are also applicable in an analogous manner to method 800 of FIG. 8. For example, method 800 optionally includes one or more of the characteristics of the various methods described below with reference to method 900, such as the second set of one or more criteria at 940 of method 900 can be assessed in response to receiving the data at 820 of method 800. For another example, method 800 optionally includes one or more of the characteristics of the various methods described below with reference to method 1000, such as the first set of one or more criteria at 1040 of method 1000 can be assessed in response to receiving the data at 820 of method 800. For another example, method 800 optionally includes one or more of the characteristics of the various methods described below with reference to method 1100, such as the first set of one or more criteria at 1140 of method 1100 can be assessed in response to receiving the data at 820 of method 800. For another example, method 800 optionally includes one or more of the characteristics of the various methods described below with reference to method 1200, such as the second set of one or more criteria at 1240 of method 1200 can be assessed in response to receiving the data at 820 of method 800. For another example, method 800 optionally includes one or more of the characteristics of the various methods described below with reference to method 1300, such as the first set of one or more criteria at 1340 of method 1300 can be assessed in response to receiving the data at 820 of method 800. For another example, method 800 optionally includes one or more of the characteristics of the various methods described below with reference to method 1400, such as the first set of one or more criteria at 1450 of method 1400 can be assessed in response to receiving the data at 820 of method 800. For another example, method 800 optionally includes one or more of the characteristics of the various methods described below with reference to method 1500, such as the first set of one or more criteria at 1550 of method 1500 can be assessed in response to receiving the data at 820 of method 800.

FIG. 9 is a flow diagram illustrating method 900 for detecting a contaminant affecting a physical component. Some operations in method 900 are, optionally, combined, the orders of some operations are, optionally, changed, and some operations are, optionally, omitted. In some examples, method 900 is performed by a compute system (e.g., compute system 100), a computer system (e.g., device 200), or an electronic device (e.g., electronic device 300). In some examples, method 900 is performed by a processor (e.g., a processing unit) of an electronic device (e.g., a computer system, a phone, a tablet, a motorized electronic device, a wearable electronic device, a personal computer, and/or an autonomous electronic device) that is in communication with an emitter (e.g., a light source, such as a laser, a light bulb, a fluorescent light, and/or a light emitting diode) and a first sensor (e.g., a camera and/or any sensor described herein).

At 910, method 900 includes, in accordance with a determination to determine whether a component (e.g., an at least partially transparent cover and/or the first sensor) (in some examples, the electronic device includes the component) has a fault (e.g., misalignment, a contaminant on the component, and/or a physical degradation or malfunction), causing, via the emitter, output of an emission (e.g., the emission is detectable by the first sensor, such as light in an image when the first sensor is a camera) (in some examples, the electronic device sends a request to the emitter to output the emission; in some examples, the electronic device executes an instruction to output the emission without sending and/or needing to send a request; in some examples, the electronic device receives a request to determine whether the component has the fault and, in response to receiving the request, causes the output of the emission; in some examples, in accordance with a determination to not determine whether the component has a fault, forgoing causation of output of the emission).

At 920, method 900 includes after causing output of the emission, receiving (e.g., causing capture of), via the first sensor, data with respect to a physical environment (e.g., an image, a temperature reading, and/or an amount of pressure).

At 930, method 900 includes in response to receiving the data and in accordance with a determination that a first set of one or more criteria is met (in some examples, the first set of one or more criteria includes a criterion that is met when the emission is not detected (e.g., a threshold amount of the emission) in the data; in some examples, the first set of one or more criteria includes a criterion that is met when the emission is detected within a predefined area, such as an area that is needed for a first operation), determining that the component has a fault (e.g., based on the data) (e.g., determining that there is a fault with respect to the component) (in some examples, the first operation is not performed in accordance with the determination that the first set is met); in some examples, the component of the electronic device is positioned over the emitter and/or the first sensor).

At 940, method 900 includes in response to receiving the data and in accordance with a determination that a second set of one or more criteria is met, performing a first operation (e.g., depth calculation, changing a state of a component of the electronic device, notifying a user, and/or any other operation that is relying on the data to be accurate) (in some examples, the first operation uses the data), wherein the second set of one or more criteria includes a criterion that is based on one or more characteristics of an artifact (e.g., a detectable portion and/or result of the emission) corresponding to the emission (e.g., the one or more characteristics are determined using the data), and wherein the second set of one or more criteria is different from the first set of one or more criteria (in some examples, in accordance with the determination that the second set of one or more criteria is met, determining that the component does not have a fault).

In some examples, the one or more characteristics of the artifact corresponding to the emission includes at least one selected from the group of size, color, shape, and location of the artifact (e.g., relative to the component).

In some examples, the first set of one or more criteria includes a criterion that is met when the artifact corresponding to the emission is not detected (e.g., based on (e.g., in and/or after or before processing) the data).

In some examples, determining that the component has a fault includes detecting a contaminant (e.g., a contaminant on the component, a contaminant that is positioned on and/or relative to the component, and/or a contaminant that is positioned outside of the component and the emitter) (e.g., water, oil, dirt, snow, and/or a bug).

In some examples, detecting the contaminant includes: in accordance with a determination that the emission is detected to have a first set of one or more characteristics based on the data, classifying the contaminant as being a first type of contaminant, wherein the first set of one or more characteristics include a first color; and in accordance with a determination that the emission is detected to have a second set of one or more characteristics based on the data, classifying the contaminant as being a second type of contaminant that is different from the first type of contaminant, wherein the second set of one or more characteristics include a second color that is different from the first color.

In some examples, the emission is light output via a light source (e.g., CCFL, EEFL, FFL, LED, radar, hot cathode fluorescent lamp (HCFL), laser, organic light emitting diode (OLED), and/or electroluminescent (EL) devices) (in some examples, the light source is outside of a field of view of the first sensor; in some examples, the emitter is the light source).

In some examples, the emission is collimated light that includes multiple wavelengths (in some examples, the light is not collimated light).

In some examples, the first sensor is a camera (e.g., a camera sensor of the camera), and wherein the data includes an image captured by the camera.

In some examples, the component includes an optical component (e.g., a cover and/or an at least partially transparent cover (referred to as a transparent cover)) in (e.g., at least partially) the optical path (line of sight and/or field-of-view) of the camera, wherein the optical component includes an embedded component (e.g., a reflecting component, such as a film, prism, 3D object, and/or a mirror, sometimes referred to as a diffuser), and wherein the first criterion is met when a contaminant is detected at a location (e.g., on and/or near) the optical component.

In some examples, method 900 further includes: in response to determining that the component has a fault, performing a corrective operation (e.g., turning on a heating component, applying a chemical, swiping the component, air drying, air blowing, scraping, and/or notifying) (in some examples, performing the operation concerning the corrective action regarding a fault causes an action (e.g., a heating component to turn on, a chemical to be applied, a physical component to swipe the component, air dryer to be turned on/off, air blower to be turned on/off, and/or scraper to move or stop moving) to be performed to correct a fault (e.g., an operation that is different from the first operation); in some examples, performing the first operation includes outputting a notification (e.g., a message to a user or a fault detection event)).

In some examples, performing the corrective operation includes: in accordance with a determination that a detected property of the emission is a first property (e.g., capture of emission is first wavelength), performing a first operation (e.g., turning on a heating component, applying a chemical, swiping the component, air drying, air blowing, scraping, and/or notifying); and in accorder with a determination that the detected property of the emission is a second property (e.g., capture of emission is second wavelength), performing a second operation different from the first operation (e.g., turning on a heating component, applying a chemical, swiping the component, air drying, air blowing, scraping, and/or notifying).

In some examples, the determination to determine whether the component has a fault occurs periodically (e.g., every second or every minute).

In some examples, the determination to determine whether the component has a fault includes a determination (e.g., in response to determining) that a sensor (e.g., of the electronic device) detected that an event (e.g., hitting a bump, a hard turn, or an accident) occurred.

In some examples, the determination to determine whether the component has a fault includes a determination (e.g., in response to determining) that a result of an operation (e.g., the first operation or a different operation) is incorrect.

Note that details of the processes described above or below with respect to methods 800 (i.e., FIG. 8), 1000 (i.e., FIG. 10), 1100 (i.e., FIG. 11), 1200 (i.e., FIG. 12), 1300 (i.e., FIG. 13), 1400 (i.e., FIG. 14), and 1500 (i.e., FIG. 15) are also applicable in an analogous manner to method 900 of FIG. 9. For example, method 900 optionally includes one or more of the characteristics of the various methods described above with reference to method 800, such as the second set of one or more criteria at 840 of method 800 can be assessed in response to receiving the data at 920 of method 900. For another example, method 900 optionally includes one or more of the characteristics of the various methods described below with reference to method 1000, such as the first set of one or more criteria at 1040 of method 1000 can be assessed in response to receiving the data at 920 of method 900. For another example, method 900 optionally includes one or more of the characteristics of the various methods described below with reference to method 1100, such as the first set of one or more criteria at 1140 of method 1100 can be assessed in response to receiving the data at 920 of method 900. For another example, method 900 optionally includes one or more of the characteristics of the various methods described below with reference to method 1200, such as the second set of one or more criteria at 1240 of method 1200 can be assessed in response to receiving the data at 920 of method 900. For another example, method 900 optionally includes one or more of the characteristics of the various methods described below with reference to method 1300, such as the first set of one or more criteria at 1340 of method 1300 can be assessed in response to receiving the data at 920 of method 900. For another example, method 900 optionally includes one or more of the characteristics of the various methods described below with reference to method 1400, such as the first set of one or more criteria at 1450 of method 1400 can be assessed in response to receiving the data at 920 of method 900. For another example, method 900 optionally includes one or more of the characteristics of the various methods described below with reference to method 1500, such as the first set of one or more criteria at 1550 of method 1500 can be assessed in response to receiving the data at 920 of method 900.

FIG. 10 is a flow diagram illustrating method 1000 for using light to detect different faults affecting a physical component. Some operations in method 1000 are, optionally, combined, the orders of some operations are, optionally, changed, and some operations are, optionally, omitted. In some examples, method 1000 is performed by a processor (e.g., a processing unit) of an electronic device (e.g., a computer system, a phone, a tablet, a motorized electronic device, a wearable electronic device, a personal computer, and/or an autonomous electronic device) that is in communication with a sensor (e.g., a camera and/or any sensor described herein).

At 1010, method 1000 includes, in accordance with a determination to determine whether a component (e.g., a physical component, such as an at least partially transparent cover and/or the sensor) (in some examples, the electronic device includes the component) has a first type (e.g., misalignment or a particular type of contaminant, such as snow, rain, or a bug) of fault, causing output of a first light that includes a first wavelength of light (in some examples, the first light includes one or more other wavelengths of light; in some examples, the first light only includes the first wavelength of light; in some examples, the first light is output via a first light source; in some examples, the electronic device sends a request to the first light source to output the first light; in some examples, the electronic device executes an instruction to output the first light without sending and/or needing to send a request; in some examples, the electronic device receives a request to determine whether the component has the first type of fault and, in response to receiving the request, causes the output of the first light; in some examples, in accordance with a determination to not determine whether the component has the first type of fault, forgoing causation of output of the first light).

At 1020, method 1000 includes, in accordance with a determination to determine whether the component has a second type (e.g., a second type of contaminant, such as snow, rain, or a bug) of fault, causing output of a second light that includes a second wavelength of light different from the first wavelength of light (in some examples, the second light includes one or more other wavelengths of light (optionally including the first wavelength of light); in some examples, the second light only includes the second wavelength of light; in some examples, the second light is output via the first light source or a second light source different from the first light source; in some examples, the electronic device sends a request to a light source to output the second light; in some examples, the electronic device executes an instruction to output the second light without sending and/or needing to send a request; in some examples, the electronic device receives a request to determine whether the component has the second type of fault (in some examples, the request is the same request that causes the first light to be output) and, in response to receiving the request, causes the output of the second light; in some examples, the first light and the second light are output at different times; in some examples, the first light and the second light are output at a time at least partially overlapping); in some examples, the second light does not include the first wavelength of light; in some examples, the first light does not include the second wavelength of light; in some examples, the determination to determine whether the component has the second type of fault is included in the determination to determine whether the component has the first type of fault; in some examples, in accordance with a determination to not determine whether the component has the second type of fault, forgoing causation of output of the second light).

At 1030, method 1000 includes, after causing output of the first light or the second light (in some examples, the following operations are performed after causing output of both the first light and the second light), receiving (e.g., causing capture of), via the sensor, data with respect to a physical environment (e.g., an image, a temperature reading, and/or an amount of pressure).

At 1040, method 1000 includes, in response to receiving the data and in accordance with a determination that a first set of one or more criteria is met, determining (e.g., using the data) that the component has the first type of fault, wherein the first set of one or more criteria includes a criterion that is met when detecting an artifact corresponding to the first light.

At 1050, method 1000 includes, in response to receiving the data and in accordance with a determination that a second set of one or more criteria is met, determining (e.g., using the data) that the component has the second type of fault, wherein the second set of one or more criteria includes a criterion that is met when detecting an artifact corresponding to the second light (in some examples, both the first type and the second type are detected using the data), and wherein the second set of one or more criteria is different from the first set of one or more criteria.

In some examples, the first light includes only (e.g., sometimes referred to as monochromatic light) the first wavelength of light (and, in some examples, to detect misalignment or a particular type of contaminant).

In some examples, the second light includes only (e.g., sometimes referred to as monochromatic light) the second wavelength of light (and, in some examples, to detect misalignment or a particular type of contaminant and/or different type of contaminant).

In some examples, the second light includes a third wavelength of light different from the second wavelength of light (and, in some examples, the second light includes collimated light that has multiple wavelengths) (e.g., and, in some examples, to detect different types of contaminants with a single light).

In some examples, the first wavelength of light includes a fourth wavelength of light different from the first wavelength of light (and, in some examples, the first light includes collimated light that has multiple wavelengths) (and, in some examples, to detect different types of contaminants with a single light). In some examples, the third wavelength of light is the same as the fourth wavelength of light. In some examples, the third wavelength of light is different from the fourth wavelength of light.

In some examples, the second light includes a number (e.g., a non zero number) of wavelengths (e.g., of light) that is greater than (or, in some examples, less than) a number of wavelengths (e.g., a non zero number) (e.g., of light) that the first light includes.

In some examples, the sensor is a camera (e.g., a camera sensor of the camera), and wherein the data includes an image captured by the camera.

In some examples, the first set of criteria includes a criterion that is met when light is not detected at a predefined location in the image (and, in some examples, the second set of criteria does not include the criterion that is met when light is not detected at the predefined location in the image).

In some examples, the second set of criteria includes a criterion that is met when a threshold amount of light is detected in the image (e.g., regardless of where the light is detected) (e.g., and/or based on whether one or more characteristics of the second light is changed in the image not expected).

In some examples, method 1000 further includes: while causing output of the first light, performing an operation (e.g., object detection, classification, and/or identification); and while causing output of the second light, forgoing performance of the operation.

In some examples the determination to determine whether the component has the first type of fault is made in response to a first event being detected (and not in response to a second event being detected), wherein the determination to determine whether the component has the second type of fault is made in response to a second event being detected (and not in response to the first event being detected), and wherein the first event is different from the second event.

Note that details of the processes described above or below with respect to methods 800 (i.e., FIG. 8), 900 (i.e., FIG. 9), 1100 (i.e., FIG. 11), 1200 (i.e., FIG. 12), 1300 (i.e., FIG. 13), 1400 (i.e., FIG. 14), and 1500 (i.e., FIG. 15) are also applicable in an analogous manner to method 1000 of FIG. 10. For example, method 1000 optionally includes one or more of the characteristics of the various methods described above with reference to method 800, such as the second set of one or more criteria at 840 of method 800 can be assessed in response to receiving the data at 1030 of method 1000. For another example, method 1000 optionally includes one or more of the characteristics of the various methods described above with reference to method 900, such as the first set of one or more criteria at 1040 of method 1000 can be assessed in response to receiving the data at 1030 of method 1000. For another example, method 1000 optionally includes one or more of the characteristics of the various methods described below with reference to method 1100, such as the first set of one or more criteria at 1140 of method 1100 can be assessed in response to receiving the data at 1030 of method 1000. For another example, method 1000 optionally includes one or more of the characteristics of the various methods described below with reference to method 1200, such as the second set of one or more criteria at 1240 of method 1200 can be assessed in response to receiving the data at 1030 of method 1000. For another example, method 1000 optionally includes one or more of the characteristics of the various methods described below with reference to method 1300, such as the first set of one or more criteria at 1340 of method 1300 can be assessed in response to receiving the data at 1030 of method 1000. For another example, method 1000 optionally includes one or more of the characteristics of the various methods described below with reference to method 1400, such as the first set of one or more criteria at 1450 of method 1400 can be assessed in response to receiving the data at 1030 of method 1000. For another example, method 1000 optionally includes one or more of the characteristics of the various methods described below with reference to method 1500, such as the first set of one or more criteria at 1550 of method 1500 can be assessed in response to receiving the data at 1030 of method 1000.

FIG. 11 is a flow diagram illustrating method 1100 for changing wavelength of light that is output based on a physical environment. Some operations in method 1100 are, optionally, combined, the orders of some operations are, optionally, changed, and some operations are, optionally, omitted. In some examples, method 1100 is performed by a processor (e.g., a processing unit) of an electronic device (e.g., a computer system, a phone, a tablet, a motorized electronic device, a wearable electronic device, a personal computer, and/or an autonomous electronic device) that is in communication with a camera.

At 1110, method 1100 includes receiving (e.g., capturing), via the camera, an image of a physical environment.

At 1120, method 1100 includes determining one or more properties (e.g., one or more colors and/or an object with the image) of the image.

At 1130, method 1100 includes receiving a request to determine whether a component (e.g., a physical component, such as an at least partially transparent cover and/or the sensor) (in some examples, the electronic device includes the component) has a fault (e.g., misalignment, a contaminant on the component, and/or a physical degradation or malfunction) (in some examples, the one or more properties are determined in response to receiving the request; in some examples, the image is captured in response to receiving the request).

At 1140, method 1100 includes, in response to receiving the request and in accordance with a determination that the one or more properties meet a first set of one or more criteria, causing output of a first light including a first wavelength of light (in some examples, the first light includes one or more other wavelengths of light; in some examples, the first light only includes the first wavelength of light; in some examples, the first light is output via a first light source; in some examples, the electronic device sends a request to the first light source to output the first light; in some examples, the electronic device executes an instruction to output the first light without sending and/or needing to send a request).

At 1150, method 1100 includes, in response to receiving the request and in accordance with a determination that the one or more properties meet a second set of one or more criteria, causing output of a second light including a second wavelength of light different from the first wavelength of light, wherein the second light is different from the first light (in some examples, the second light includes one or more other wavelengths of light (optionally including the first wavelength of light); in some examples, the second light only includes the second wavelength of light; in some examples, the second light is output via the first light source or a second light source different from the first light source; in some examples, the electronic device sends a request to a light source to output the second light; in some examples, the electronic device executes an instruction to output the second light without sending and/or needing to send a request; in some examples, the second light does not include the first wavelength of light; in some examples, the first light does not include the second wavelength of light), and wherein the second set of one or more criteria is different from the first set of one or more criteria.

In some examples, the one or more properties are determined based on one or more predefined locations within the image.

In some examples, the one or more properties are determined with respect to a majority of data in the image (e.g., the overall image and/or more than 50% of an image).

In some examples, the one or more properties include a color (and/or hue) in the image (e.g., one or more colors in the image).

In some examples, the color (and/or hue) in the image is a dominant color (and/or hue) (e.g., primary color, majority color, a color that is present more than other colors, the average color, and/or the median color) of the image.

In some examples, the first wavelength or the second wavelength is a different wavelength than a wavelength of the color of the image.

In some examples, determining whether the component has a fault is determined based on data from a second image of the physical environment that is captured by the camera, and wherein the second image is different from the first image.

Note that details of the processes described above or below with respect to methods 800 (i.e., FIG. 8), 900 (i.e., FIG. 9), 1000 (i.e., FIG. 10), 1200 (i.e., FIG. 12), 1300 (i.e., FIG. 13), 1400 (i.e., FIG. 14), and 1500 (i.e., FIG. 15) are also applicable in an analogous manner to method 1100 of FIG. 11. For example, method 1100 optionally includes one or more of the characteristics of the various methods described above with reference to method 800, such as the data used with the second set of one or more criteria at 840 of method 800 can be a result of the first light output at 1150 of method 1100. For another example, method 1100 optionally includes one or more of the characteristics of the various methods described above with reference to method 900, such as the data used in the first set of one or more criteria at 930 of method 900 can be a result of the first light output at 1150 of method 1100. For another example, method 1100 optionally includes one or more of the characteristics of the various methods described above with reference to method 1200, such as the data used in the first set of one or more criteria at 1140 of method 1100 can be a result of the first light output at 1150 of method 1100. For another example, method 1100 optionally includes one or more of the characteristics of the various methods described below with reference to method 1200, such as the image used in the second set of one or more criteria at 1240 of method 1200 can include a result of the first light output at 1150 of method 1100. For another example, method 1100 optionally includes one or more of the characteristics of the various methods described below with reference to method 1300, such as the image used in the first set of one or more criteria at 1340 of method 1300 can include a result of the first light output at 1150 of method 1100. For another example, method 1100 optionally includes one or more of the characteristics of the various methods described below with reference to method 1400, such as the image used in the first set of one or more criteria at 1450 of method 1400 can include a result of the first light output at 1150 of method 1100. For another example, method 1100 optionally includes one or more of the characteristics of the various methods described below with reference to method 1500, such as the image used with the first set of one or more criteria at 1550 of method 1500 can include a result of the first light output at 1150 of method 1100.

FIG. 12 is a flow diagram illustrating method 1200 for detecting faults with multiple physical components at the same time. Some operations in method 1200 are, optionally, combined, the orders of some operations are, optionally, changed, and some operations are, optionally, omitted. In some examples, method 1200 is performed by a processor (e.g., a processing unit) of an electronic device (e.g., a computer system, a phone, a tablet, a motorized electronic device, a wearable electronic device, a personal computer, and/or an autonomous electronic device) that is in communication with a camera.

At 1210, method 1200 includes causing output of light (in some examples, the light is output via a first light source with respect to a first optical component and a second light source with respect to a second light source; in some examples, the light is output via a single light source with respect to both the first optical component and the second optical component; in some examples, the electronic device sends a request to the first light source to output the light and a request to the second light source to output the light; in some examples, the electronic device executes an instruction to output the light without sending and/or needing to send a request; in some examples, the electronic device receives a request to detect a fault of a first optical component of the electronic device and, in response to receiving the request, causes the output of the first light).

At 1220, method 1200 includes, after causing output of the light, receiving (e.g., causing capture of), via the camera, an image of a physical environment (e.g., an image, a temperature reading, and/or an amount of pressure).

At 1230, method 1200 includes, in response to receiving the image and in accordance with a determination that a first set of one or more criteria is met, determining (e.g., using the data) that a first optical component (e.g., a physical component, such as an at least partially transparent cover and/or the sensor) (in some examples, the electronic device includes the first optical component) has a fault (e.g., misalignment or a particular type of contaminant, such as snow, rain, or a bug), wherein the first set of one or more criteria includes a criterion that is met when detecting an artifact corresponding to the first light in the image.

At 1240, method 1200 includes, in response to receiving the image and in accordance with a determination that a second set of one or more criteria is met, determining (e.g., using the data and/or based on the data) that a second optical component, different from the first optical component, has a fault (e.g., misalignment or a second type of contaminant, such as snow, rain, or a bug) (and, in some examples, without determining that the first optical component has a fault, wherein the second set of one or more criteria includes a criterion that is met when detecting an artifact corresponding to the second light in the image (in some examples, both the first type and the second type are detected using the image), wherein the second set of one or more criteria is different from the first set of one or more criteria.

In some examples, causing the output of light includes: causing a first light source to output a first light (e.g., in accordance with a determination that the electronic device should be configured to detect a first type of fault); and causing a second light source to output a second light, wherein the second light source is different from the first light source (e.g., in accordance with a determination that the electronic device should be configured to detect a second type of fault that is different from the first type of fault).

In some examples, the first light has a first set of one or more wavelengths, wherein the second light has a second set of one or more wavelengths, and wherein the first set of one or more wavelengths is different from (e.g., includes more or less wavelengths of light) the second set of one or more wavelengths.

In some examples, the first light is output at a first time, and wherein the second light is output at a second time that is different from the first time.

In some examples, the first optical component and the second optical component are in the optical path (e.g., totally and/or at least partially) of the camera sensor.

In some examples, the first set of one or more criteria and the second set of one or more criteria are met in response to receiving the image, and wherein the first fault is different from the second fault.

In some examples, the first fault and the second fault are detected based on data from the image.

Note that details of the processes described above or below with respect to methods 800 (i.e., FIG. 8), 900 (i.e., FIG. 9), 1000 (i.e., FIG. 10), 1100 (i.e., FIG. 11), 1300 (i.e., FIG. 13), 1400 (i.e., FIG. 14), and 1500 (i.e., FIG. 15) are also applicable in an analogous manner to method 1200 of FIG. 12. For example, method 1200 optionally includes one or more of the characteristics of the various methods described above with reference to method 800, such as the data received at 820 of method 800 can be the image received at 1220 of method 1200. For another example, method 1200 optionally includes one or more of the characteristics of the various methods described above with reference to method 900, such as the data received at 920 of method 900 can be the image received at 1220 of method 1200. For another example, method 1200 optionally includes one or more of the characteristics of the various methods described above with reference to method 1000, such as the data received at 1130 of method 1100 can be the image received at 1220 of method 1200. For another example, method 1200 optionally includes one or more of the characteristics of the various methods described above with reference to method 1100, such as light output at 1140 of method 1100 can be the light output at 1210 of method 1200. For another example, method 1200 optionally includes one or more of the characteristics of the various methods described below with reference to method 1300, such as the image used in the first set of one or more criteria at 1340 of method 1300 can be the image received at 1220 of method 1200. For another example, method 1200 optionally includes one or more of the characteristics of the various methods described below with reference to method 1400, such as the image used in the first set of one or more criteria at 1450 of method 1400 can be the image received at 1220 of method 1200. For another example, method 1200 optionally includes one or more of the characteristics of the various methods described below with reference to method 1500, such as the first image received at 1540 of method 1500 can be the image received at 1220 of method 1200.

FIG. 13 is a flow diagram illustrating method 1300 for detecting a fault with a camera. Some operations in method 1300 are, optionally, combined, the orders of some operations are, optionally, changed, and some operations are, optionally, omitted. In some examples, method 1300 is performed by a processor (e.g., a processing unit) of an electronic device (e.g., a computer system, a phone, a tablet, a motorized electronic device, a wearable electronic device, a personal computer, and/or an autonomous electronic device) that is in communication with a light source, a first camera, and a second camera.

At 1310, method 1300 includes causing output, via the light source, of light (in some examples, the electronic device sends a request to the light source to output the light; in some examples, the electronic device executes an instruction to output the light without sending and/or needing to send a request; in some examples, the electronic device receives a request to determine that a component has a fault and, in response to receiving the request, causes the output of the light).

At 1320, method 1300 includes, after causing output of the light, receiving (e.g., causing capture of), via the first camera, a first image of a physical environment.

At 1330, method 1300 includes, after causing output of the light, receiving (e.g., causing capture of), via the second camera (e.g., that is different form the first camera), a second image (e.g., that is different from the first image) of the physical environment.

At 1340, method 1300 includes, in response to receiving the first image or the second image (in some examples, the following operations (e.g., as described in relation to 1340 and 1350) are performed in response to receiving both the first image and the second image) and in accordance with a determination that a first set of one or more criteria are met, determining that an alignment of the first camera with respect to the second camera has not changed, wherein the first set of one or more criteria includes a criterion that is based on identifying a location of an artifact corresponding to the light in the first image and the second image.

At 1350, method 1300 includes, in response to receiving the first image or the second image and in accordance with a determination that a second set of one or more criteria are met, determining that an alignment of the first camera with respect to the second camera has changed (in some examples, the second set includes a criterion that is met when the artifact is not identified in the first image or the second image; in some examples, the second set includes a criterion that that is when an artifact is identified in the first image or the second image at a location different), wherein the second set of one or more criteria is different from the first set of one or more criteria.

In some examples, the light is collimated light of a single wavelength (e.g., sometimes referred to as monochromatic light).

In some examples, the location of the artifact corresponding to the light in the first image and the second image is aligned to an edge of a field of view of the first camera or the second camera (in some examples, the location is aligned to an edge of a field of view of both the first camera and the second camera).

In some examples, method 1300 further includes, in response to determining that the alignment of the first camera with respect to the second camera has changed, instructing one or more models to compensate for the alignment (and, in some examples, without moving one or more of the first camera or the second camera).

In some examples, method 1300 further includes, in response to determining that the alignment of the first camera with respect to the second camera has changed, causing the first camera or the second camera to move (e.g., to compensate for the change in orientation and/or to move back to an original orientation) (and, in some examples, without instructing one or more models to compensate for the first change in orientation).

In some examples, method 1300 further includes, before receiving the first image or the second image, receiving, via the first camera, a third image of the physical environment; and in response to receiving the third image, performing an object recognition operation (e.g., classifying, identifying, and/or detecting using machine learning and/or an object recognition algorithm) using the third image.

In some examples, method 1300 further includes performing an object recognition operation (e.g., classifying, identifying, and/or detecting using machine learning and/or an object recognition algorithm) using the first image or the second image (in some examples, the object recognition operation is performing using the first image and the second image).

In some examples, the first set of one or more criteria includes a second criterion, different from the criterion, that is based on identifying a second location of a second artifact, different from the artifact, corresponding to the light in the first image and the second image.

Note that details of the processes described above or below with respect to methods 800 (i.e., FIG. 8), 900 (i.e., FIG. 9), 1000 (i.e., FIG. 10), 1100 (i.e., FIG. 11), 1200 (i.e., FIG. 12), 1400 (i.e., FIG. 14), and 1500 (i.e., FIG. 15) are also applicable in an analogous manner to method 1300 of FIG. 13. For example, method 1300 optionally includes one or more of the characteristics of the various methods described above with reference to method 800, such as the data received at 820 of method 800 can be the first image received at 1320 of method 1300. For another example, method 1300 optionally includes one or more of the characteristics of the various methods described above with reference to method 900, such as the data received at 920 of method 900 can be the first image received at 1320 of method 1300. For another example, method 1300 optionally includes one or more of the characteristics of the various methods described above with reference to method 1000, such as the data received at 1030 of method 1000 can be the first image received at 1320 of method 1300. For another example, method 1300 optionally includes one or more of the characteristics of the various methods described above with reference to method 1100, such as light output at 1140 of method 1100 can be the light output at 1310 of method 1300. For another example, method 1300 optionally includes one or more of the characteristics of the various methods described above with reference to method 1200, such as the image received at 1220 of method 1200 can be the first image received at 1320 of method 1300. For another example, method 1300 optionally includes one or more of the characteristics of the various methods described below with reference to method 1400, such as the image used in the first set of one or more criteria at 1450 of method 1400 can be the first image received at 1320 of method 1300. For another example, method 1300 optionally includes one or more of the characteristics of the various methods described below with reference to method 1500, such as the first image received at 1540 of method 1500 can be the first image received at 1320 of method 1300.

FIG. 14 is a flow diagram illustrating method 1400 for estimating a location of an artifact based on environmental data. Some operations in method 1400 are, optionally, combined, the orders of some operations are, optionally, changed, and some operations are, optionally, omitted. In some examples, method 1400 is performed by a processor (e.g., a processing unit) of an electronic device (e.g., a computer system, a phone, a tablet, a motorized electronic device, a wearable electronic device, a personal computer, and/or an autonomous electronic device) that is in communication with an environmental sensor (e.g., a thermometer, an accelerometer, a gyroscope, a speedometer, an inertial sensor, and/or a humidity sensor), a light source, and a camera (in some examples, the camera includes the environmental sensor).

At 1410, method 1400 includes identifying, via the environmental sensor, environmental data (e.g., a temperature, an amount of rotation, an amount of humidity, or any sensor detecting data with respect to a physical environment).

At 1420, method 1400 includes determining, based on the environmental data, a predicted location within an image captured by the camera of an artifact corresponding to light output by the light source.

At 1430, method 1400 includes causing output, via the light source, of first light (in some examples, the electronic device sends a request to the light source to output the first light; in some examples, the electronic device executes an instruction to output the first light without sending and/or needing to send a request; in some examples, the electronic device receives a request to detect a fault of a component of the electronic device and, in response to receiving the request, causes the output of the first light).

At 1440, method 1400 includes, after causing output of the first light, receiving (e.g., causing capture of), via the camera, a first image of a physical environment.

At 1450, method 1400 includes, in response to receiving the first image and in accordance with a determination that a first set of one or more criteria is met, determining that a component (e.g., a physical component, such as an at least partially transparent cover and/or the sensor) (in some examples, the electronic device includes the component) does not have a fault (e.g., component is in a fault state, component is being covered up, component is misaligned, and/or focus shift) (e.g., using the data), wherein the first set of one or more criteria includes a criterion that is met when an artifact corresponding to the first light is detected in the first image at the predicted location.

At 1460, method 1400 includes, in response to receiving the first image and in accordance with a determination that the first set of one or more criteria is not met, determining that the component has a fault (in some examples, the first set of one or more criteria includes a criterion that is not met when an artifact corresponding to the first light is detected in the first image at a location that is different from the predicted location; in some examples, the first set of one or more criteria includes a criterion that is not met when an artifact is not detected in the first image).

In some examples, the camera includes the environmental sensor (e.g., a sensor (e.g., a thermometer, an accelerometer, a gyroscope, a speedometer, an inertial sensor, and/or a humidity sensor) that detects one or more characteristics (e.g., temperature, moisture, windspeed, and/or pressure) in the physical environment).

In some examples, the electronic device includes the environmental sensor (and, in some examples, the camera does not include the environmental sensor).

In some examples, the electronic device does not include the environmental sensor, and wherein identifying the environmental data includes receiving a message (e.g., at the electronic device via one or more wired and/or wireless connections to the environmental sensor) that includes the environmental data.

In some examples, the environmental sensor is a sensor selected from a group of a thermometer, an accelerometer, a gyroscope, an inertial sensor, a speedometer, and a humidity sensor.

In some examples, method 1400 further includes: after identifying the environmental data, determining a focal length of the camera using (e.g., at least) the environmental data (in some examples, the focal length of the camera changes based on environmental data; in some examples, the focal length of the camera is estimated using a look-up table that includes different focal lengths for different environmental data measurements).

In some examples, in accordance with a determination that the environmental data changed in a first manner (e.g., at a first rate, increase, and/or decreases) over a period of time (e.g., 1-1000 seconds), the predicted location is a first location (e.g., determined by the processor, the electronic device, and/or another electronic device); and, in accordance with a determination that the environmental data changed in a second manner (e.g., at a first rate, increase, and/or decreases), different from the first manner, over the period of time (e.g., 1-1000 seconds), the predicted location is a second location (e.g., determined by the processor, the electronic device, and/or another electronic device) that is different from the first location.

In some examples, the electronic device includes the light source and the camera (in some examples, the electronic device does not include the light source; in some examples, the electronic device does not include the camera).

Note that details of the processes described above or below with respect to methods 800 (i.e., FIG. 8), 900 (i.e., FIG. 9), 1000 (i.e., FIG. 10), 1100 (i.e., FIG. 11), 1200 (i.e., FIG. 12), 1300 (i.e., FIG. 13), and 1500 (i.e., FIG. 15) are also applicable in an analogous manner to method 1400 of FIG. 14. For example, method 1400 optionally includes one or more of the characteristics of the various methods described above with reference to method 800, such as the data received at 820 of method 800 can be the first image received at 1440 of method 1400. For another example, method 1400 optionally includes one or more of the characteristics of the various methods described above with reference to method 900, such as the data received at 920 of method 900 can be the first image received at 1440 of method 1400. For another example, method 1400 optionally includes one or more of the characteristics of the various methods described above with reference to method 1000, such as the data received at 1030 of method 1000 can be the first image received at 1440 of method 1400. For another example, method 1400 optionally includes one or more of the characteristics of the various methods described above with reference to method 1100, such as light output at 1140 of method 1100 can be the first light output at 1430 of method 1400. For another example, method 1400 optionally includes one or more of the characteristics of the various methods described above with reference to method 1200, such as the image received at 1220 of method 1200 can be the first image received at 1440 of method 1400. For another example, method 1400 optionally includes one or more of the characteristics of the various methods described above with reference to method 1300, such as the first image received at 1320 of method 1300 can be the first image received at 1440 of method 1400. For another example, method 1400 optionally includes one or more of the characteristics of the various methods described below with reference to method 1500, such as the first image received at 1540 of method 1500 can be the first image received at 1440 of method 1400.

FIG. 15 is a flow diagram illustrating method 1500 for estimating a location of an artifact based on an indication of time. Some operations in method 1500 are, optionally, combined, the orders of some operations are, optionally, changed, and some operations are, optionally, omitted. In some examples, method 1500 is performed by a processor (e.g., a processing unit) of an electronic device (e.g., a computer system, a phone, a tablet, a motorized electronic device, a wearable electronic device, a personal computer, and/or an autonomous electronic device) that is in communication with a light source and a camera (in some examples, the camera includes the environmental sensor).

At 1510, method 1500 includes receiving an indication of time (e.g., a current time, a number of power cycles, and/or a length of time the device has been on).

At 1520, method 1500 includes determining, based on the indication of time, a predicted location within an image captured by the camera of an artifact corresponding to light output by the light source (in some examples, at a first time, the predicted location is determined to be a first location using the first time; in some examples, at a second instance in time, the predicted location is determined to be a second location using the second time, wherein the second time is different from the first time and the first location is different from the second location).

At 1530, method 1500 includes causing output, via the light source, of first light (in some examples, the electronic device sends a request to the light source to output the first light; in some examples, the electronic device executes an instruction to output the first light without sending and/or needing to send a request; in some examples, the electronic device receives a request to detect a fault of a component of the electronic device and, in response to receiving the request, causes the output of the first light).

At 1540, method 1500 includes, after causing output of the first light, receiving (e.g., causing capture of), via the camera, a first image of a physical environment.

At 1550, method 1500 includes, in response to receiving the first image and in accordance with a determination that a first set of one or more criteria is met, determining that a component (e.g., a physical component, such as an at least partially transparent cover and/or the sensor) (in some examples, the electronic device includes the component) does not have a fault (e.g., component is in a fault state, component is being covered up, component is misaligned, and/or focus shift) (e.g., using the data), wherein the first set of one or more criteria includes a criterion that is met when an artifact corresponding to the first light is detected in the first image at the predicted location.

At 1560, method 1500 includes, in response to receiving the first image and in accordance with a determination that the first set of one or more criteria is not met, determining that the component has a fault (in some examples, the first set of one or more criteria includes a criterion that is not met when an artifact corresponding to the first light is detected in the first image at a location that is different from the predicted location; in some examples, the first set of one or more criteria includes a criterion that is not met when an artifact is not detected in the first image).

In some examples, the indication of time includes (and/or, in some embodiments, indicates and/or is) a current time. In such examples, method 1500 further includes: determining, based on the current time, an estimated focal length of the camera, wherein the predicted location is determined based on the estimated focal length of the camera (in some examples, if the current time is a third time, the estimated focal length is a first focal length; and if the current time is a fourth time that is different from the third time, the estimated focal length is a second focal length that is different from the first focal length).

In some examples, the indication of time includes an indication of a number of power cycles of the camera (e.g., a number of times that the camera has transitioned between a first power mode (e.g., on, off, asleep, awake, active, inactive, and/or hibernate) to a second power mode that is different from the first power mode)) (e.g., from on to off, from on to off to on, from asleep to awake, from a reduced power mode to a normal power mode (and/or a full power mode)), and wherein the predicted location is determined based on the number of power cycles of the camera (in some examples, if the number of power cycles is a first number, the predicted location is a first location, and if the number of power cycles is a second number that is different from the first number, the predicted location is a second location that is different from the first location).

In some examples, the predicted location is determined based on an amount of time that the camera has been in a first power mode (e.g., an on state (e.g., turned on and/or powered on) awake state, active state, and/or a state where the camera is not configured to capture one or more images in response to detecting a request to capture the one or more images) since last being in a second power mode (e.g., an off state (e.g., turned off and/or powered off), a hibernate state, inactive state, a sleep state, and/or a state where the camera is not configured to capture one or more images in response to detecting a request to capture the one or more images), wherein the camera is configured to use more energy (e.g., power, such as no power in the second power mode) while operating in the first power mode than while operating in the second power mode.

In some examples, the predicted location is determined based on an age determined for a component (e.g., the light source, the camera, or an optical component (e.g., an at least partially transparent cover (referred to as a transparent cover)) in (e.g., at least partially) the optical path of the camera) of the electronic device (in some examples, if the age is a first age, the predicted location is a first location; in some examples, if the age is a second age that is different from the first age, the predicted location is a second location that is different from the first location).

In some examples, method 1500 further includes: after determining the predicted location, determining, based on a second indication of time (in some examples, the second indication of time is received after receiving the indication of time; in some examples, the second indication of time is tracked by the processor since receiving the indication of time), a second predicted location within an image captured by the camera of an artifact corresponding to light output by the light source, wherein the second predicted location (e.g., an area and/or one or more points in space) is different from the predicted location (e.g., an area and/or one or more points in space) (in some examples, the second predicted location covers a larger area of the image than the predicted location).

In some examples, the electronic device includes the light source and the camera.

In some examples, method 1500 further includes: determining, based on the indication of time, a third predicted location within an image captured by the camera of an artifact corresponding to light output by the light source, wherein the third predicted location (e.g., an area and/or one or more points in space) (in some examples, the second predicted location covers a larger area of the image than the predicted location) is separate (e.g., different, is not encompassed by and does not encompass, and/or spaced a part from) from the predicted location, and wherein the first set of one or more criteria includes a criterion that is met when a second artifact is detected at the third predicted location.

Note that details of the processes described above or below with respect to methods 800 (i.e., FIG. 8), 900 (i.e., FIG. 9), 1000 (i.e., FIG. 10), 1100 (i.e., FIG. 11), 1200 (i.e., FIG. 12), 1300 (i.e., FIG. 13), and 1400 (i.e., FIG. 14) are also applicable in an analogous manner to method 1500 of FIG. 15. For example, method 1500 optionally includes one or more of the characteristics of the various methods described above with reference to method 800, such as the data received at 820 of method 800 can be the first image received at 1540 of method 1500. For another example, method 1500 optionally includes one or more of the characteristics of the various methods described above with reference to method 900, such as the data received at 920 of method 900 can be the first image received at 1540 of method 1500. For another example, method 1500 optionally includes one or more of the characteristics of the various methods described above with reference to method 1000, such as the data received at 1030 of method 1000 can be the first image received at 1540 of method 1500. For another example, method 1500 optionally includes one or more of the characteristics of the various methods described above with reference to method 1100, such as light output at 1140 of method 1100 can be the first light output at 1530 of method 1500. For another example, method 1500 optionally includes one or more of the characteristics of the various methods described above with reference to method 1200, such as the image received at 1220 of method 1200 can be the first image received at 1540 of method 1500. For another example, method 1500 optionally includes one or more of the characteristics of the various methods described above with reference to method 1300, such as the first image received at 1320 of method 1300 can be the first image received at 1540 of method 1500. For another example, method 1500 optionally includes one or more of the characteristics of the various methods described below with reference to method 1400, such as the first image received at 1440 of method 1400 can be the first image received at 1540 of method 1500.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. A method, comprising:
in accordance with a determination to determine whether a component has a fault, causing, via an emitter, output of an emission;
after causing output of the emission, receiving, via a first sensor, data with respect to a physical environment; and
in response to receiving the data:
in accordance with a determination that a first set of one or more criteria is met, determining that the component has a fault; and
in accordance with a determination that a second set of one or more criteria is met, performing a first operation, wherein the second set of one or more criteria includes a criterion that is based on one or more characteristics of an artifact corresponding to the emission, and wherein the second set of one or more criteria is different from the first set of one or more criteria.

2. The method of claim 1, wherein the one or more characteristics of the artifact corresponding to the emission includes at least one selected from the group of size, color, shape, and location of the artifact.

3. The method of claim 1, wherein the first set of one or more criteria includes a criterion that is met when the artifact corresponding to the emission is not detected.

4. The method of claim 1, wherein determining that the component has a fault includes detecting a contaminant.

5. The method of claim 4, detecting the contaminant includes:
in accordance with a determination that the emission is detected to have a first set of one or more characteristics based on the data, classifying the contaminant as being a first type of contaminant, wherein the first set of one or more characteristics include a first color; and
in accordance with a determination that the emission is detected to have a second set of one or more characteristics based on the data, classifying the contaminant as being a second type of contaminant that is different from the first type of contaminant, wherein the second set of one or more characteristics include a second color that is different from the first color.

6. The method of claim 1, wherein the emission is light output via a light source.

7. The method of claim 1, wherein the emission is collimated light that includes multiple wavelengths.

8. The method of claim 1, wherein the first sensor is a camera, and wherein the data includes an image captured by the camera.

9. The method of claim 8, wherein the component includes an optical component in the optical path of the camera, wherein the optical component includes an embedded component, and wherein the criterion is met when a contaminant is detected at a location of the optical component.

10. The method of claim 1, further comprising:
in response to determining that the component has a fault, performing a corrective operation.

11. The method of claim 1, wherein performing the corrective operation includes:
in accordance with a determination that a detected property of the emission is a first property, performing a first operation; and
in accorder with a determination that the detected property of the emission is a second property, performing a second operation different from the first operation.

12. The method of claim 1, wherein the determination to determine whether the component has a fault occurs periodically.

13. The method of claim 1, wherein the determination to determine whether the component has a fault includes a determination that a detected that an event occurred.

14. The method of claim 1, wherein the determination to determine whether the component has a fault includes a determination that a result of an operation is incorrect.

15. A non-transitory computer-readable storage medium storing one or more programs configured to be executed by one or more processors of an electronic device that is in communication with an emitter and a first sensor, the one or more programs including instructions for:
in accordance with a determination to determine whether a component has a fault, causing, via the emitter, output of an emission;
after causing output of the emission, receiving, via the first sensor, data with respect to a physical environment; and
in response to receiving the data:
in accordance with a determination that a first set of one or more criteria is met, determining that the component has a fault; and
in accordance with a determination that a second set of one or more criteria is met, performing a first operation, wherein the second set of one or more criteria includes a criterion that is based on one or more characteristics of an artifact corresponding to the emission, and wherein the second set of one or more criteria is different from the first set of one or more criteria.

16. An electronic device, comprising:
an emitter;
a first sensor;
one or more processors; and
memory storing one or more programs configured to be executed by the one or more processors, the one or more programs including instructions for:
in accordance with a determination to determine whether a component has a fault, causing, via the emitter, output of an emission;
after causing output of the emission, receiving, via the first sensor, data with respect to a physical environment; and
in response to receiving the data:
in accordance with a determination that a first set of one or more criteria is met, determining that the component has a fault; and
in accordance with a determination that a second set of one or more criteria is met, performing a first operation, wherein the second set of one or more criteria includes a criterion that is based on one or more characteristics of an artifact corresponding to the emission, and wherein the second set of one or more criteria is different from the first set of one or more criteria.
